(19) United States
(12) Patent Application Publication
(10) Pub. No.: US 2015/0169220 A1
(43) Pub. Date: Jun. 18, 2015

(54) STORAGE CONTROL DEVICE AND STORAGE CONTROL METHOD

(71) Applicant: FUJITSU LIMITED, Kawasaki-shi (JP)

(72) Inventor: Hajime Kondo, Kawasaki (JP)

(21) Appl. No.: 14/524,541

(22) Filed: Oct. 27, 2014

(30) Foreign Application Priority Data
Dec. 13, 2013 (JP) 2013-258707

(51) Int. Cl. G06F 3/06

(52) U.S. Cl. CPC G06F 3/061; G06F 3/0685; G06F 3/065; G06F 3/0665

(57) ABSTRACT

A storage control device includes a storage configured to store correspondence information associating, with one another, a first volume, a second volume storing data of the first volume at a first time point, and a third volume storing data of the first volume at a second time point after the first time point in a first storage apparatus; a processor; and a memory which stores a plurality of instructions, which when executed by the processor, cause the processor to execute: controlling which extracts data corresponding to a storage region where a differential exists between the first volume and the second volume from the third volume based on the correspondence information in response to an acceptance of a copy request for the data in the first volume at the second time point to a fourth volume in a second storage apparatus in which the data of the first volume.

### CROSS-REFERENCE TO RELATED APPLICATION

This application is based upon and claims the benefit of priority of the prior Japanese Patent Application No. 2013-258707, filed on Dec. 13, 2013, the entire contents of which are incorporated herein by reference.

### FIELD

The embodiments discussed herein are related to a storage control device, a storage control method, and a storage control program.

### BACKGROUND

As countermeasures against data loss of business volumes due to natural disasters or the like, backup to a remote site has been performed by utilizing a copy function of a storage apparatus. When copy is directly carried out from a business volume to a volume in a storage apparatus in a remote site, input and output (I/O) performances to the business volume may be affected.

Accordingly, there may be such a case that a snapshot of a business volume, or a data copy at one time point, is created in the same storage apparatus as that for the business volume, and data is transferred from the created copied volume to that in the remote site. The copied volume created at this time may often be created by a method of storing only differential data in consideration of capacity efficiency in the storage apparatus.

A related-art technique includes, for example, Japanese Laid-open Patent Publication No. 2005-267569 that discloses a technique that a virtual logical volume of a specific generation is created by using a snapshot management table to manage a relationship between differential data for respective generations and a remote copy is created by using the virtual logical volume. In addition, Japanese National Publication of International Patent Application No. 2013-509646 discloses a technique that data is transferred to a storage by utilizing a metadata virtual hard drive (VHD) and a differential VHD.

### SUMMARY

In accordance with an aspect of the embodiments, a storage control device includes a storage configured to store correspondence information associating, with one another, a first volume, a second volume storing data of the first volume at a first time point, and a third volume storing data of the first volume at a second time point after the first time point in a first storage apparatus; a processor; and a memory which stores a plurality of instructions, which when executed by the processor, cause the processor to execute: controlling which extracts data corresponding to a storage region where a differential exists between the first volume and the second volume from the third volume based on the correspondence information in response to an acceptance of a copy request for the data in the first volume at the second time point to a fourth volume in a second storage apparatus in which the data of the first volume at the first time point has been copied and to transmit the extracted data to the second storage apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an exemplary control method according to a present embodiment;

FIG. 2 is a diagram illustrating an exemplary system configuration of a system;

FIG. 3 is a diagram illustrating an exemplary device configuration of a storage apparatus;

FIG. 4 is a block diagram illustrating an exemplary hardware configuration of a PU or the like;

FIG. 5 is a diagram illustrating exemplary storage contents of a copy information management table;

FIG. 6 is a diagram illustrating exemplary storage contents of a pseudo-volume management table;

FIG. 7 is a diagram (No. 1) illustrating exemplary updates of a differential bitmap table;

FIG. 8 is a diagram (No. 2) illustrating exemplary updates of the differential bitmap table;

FIG. 9 is a block diagram illustrating an exemplary functional configuration of a PU#1;

FIG. 10 is a diagram (No. 1) illustrating exemplary control processing of the storage apparatus;

FIG. 11 is a diagram (No. 2) illustrating exemplary control processing of the storage apparatus;

FIG. 12 is a diagram (No. 3) illustrating exemplary control processing of the storage apparatus;

FIG. 13 is a diagram (No. 4) illustrating exemplary control processing of the storage apparatus;

FIG. 14 is a diagram (No. 5) illustrating exemplary control processing of the storage apparatus;

FIG. 15 is a diagram (No. 6) illustrating exemplary control processing of the storage apparatus;

FIG. 16 is a diagram (No. 1) illustrating an exemplary differential reflection of a remote copy;

FIG. 17 is a diagram (No. 2) illustrating an exemplary differential reflection of the remote copy;

FIG. 18 is a diagram (No. 3) illustrating an exemplary differential reflection of the remote copy;

FIG. 19 is a diagram (No. 4) illustrating an exemplary differential reflection of the remote copy;

FIG. 20 is a diagram (No. 5) illustrating an exemplary differential reflection of the remote copy;

FIG. 21 is a diagram (No. 6) illustrating an exemplary differential reflection of the remote copy;

FIG. 22 is a flowchart illustrating an example of a COW copy start processing procedure of the PU#1 in the storage apparatus;

FIG. 23 is a flowchart illustrating an example of a WRITE processing procedure of the PU#1 in the storage apparatus;

FIG. 24 is a flowchart (No. 1) illustrating an example of a remote copy start processing procedure of the PU#1 in the storage apparatus;

FIG. 25 is a flowchart (No. 2) illustrating an example of a remote copy start processing procedure of the PU#1 in the storage apparatus; and

FIG. 26 is a flowchart illustrating an example of a COW copy stop processing procedure of the PU#1 in the storage apparatus.

### DESCRIPTION OF EMBODIMENTS

Hereinafter, embodiments of a storage control device, a control method, and a control program according to the present disclosure are described by referring to the drawings.

### (Embodiment of Control Method)

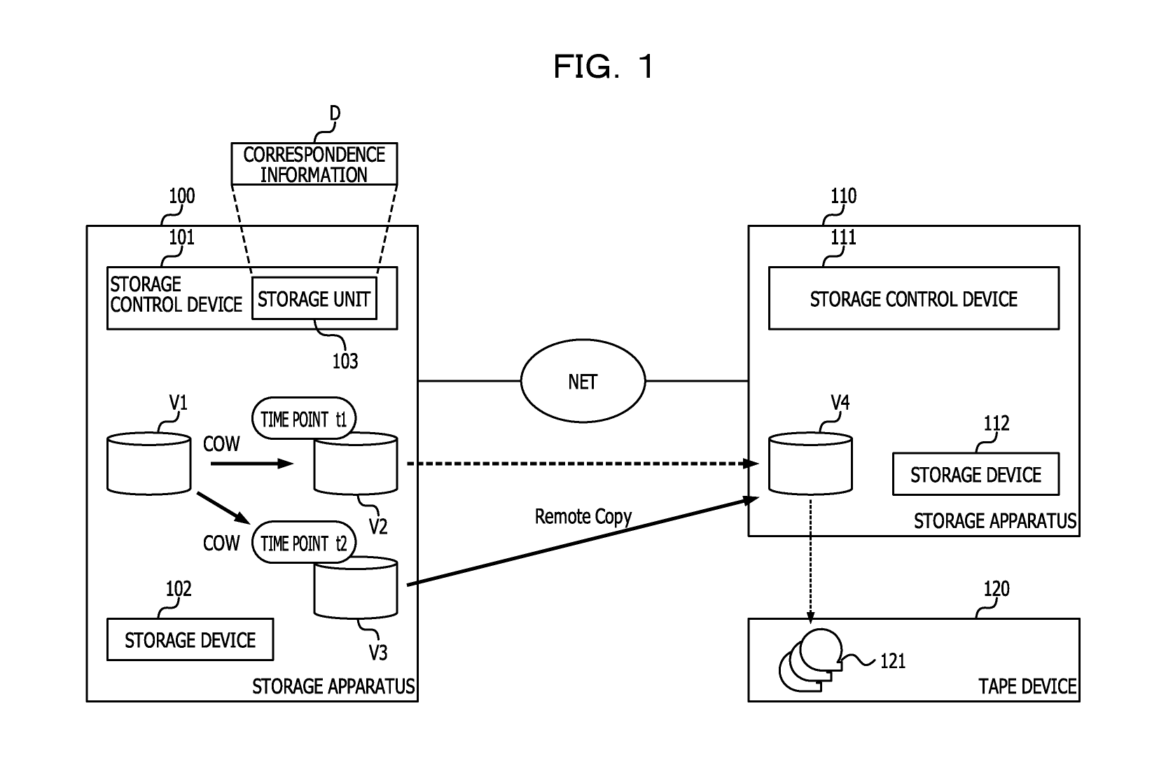

FIG. 1 is a diagram illustrating an exemplary control method according to the present embodiment. In FIG. 1, a storage apparatus 100 includes a storage control device 101 and a storage device 102. Similarly, a storage apparatus 110 includes a storage control device 111 and a storage device 112. The storage apparatus 100 and the storage apparatus 110 are connected with each other through a wired or wireless network.

The storage control device 101 is a computer configured to control the storage apparatus 100. For example, the storage control device 101 controls accesses to volumes V1 to V3 in the storage apparatus 100. Similarly, the storage control device 111 is a computer configured to control the storage apparatus 110. For example, the storage control device 111 controls an access to a volume V4 in the storage apparatus 110.

The storage devices 102 and 112 store data. For example, each of the storage devices 102 and 112 may include a physical storage device such as a hard disk, an optical disk, or a flash memory, or may include a Logical Unit Number (LUN), which is a logical storage device.

The volume is a storage region being a management unit for each of the storage apparatuses 100 and 110 and is implemented by each of the storage devices 102 and 112. The volume may be a logical volume in which partitions in multiple physical storage devices or in a storage device (a hard disk, for example) are grouped and virtually used as one volume.

For the purpose of disaster countermeasures and the like, assumed here is a case that data of the volume V1 in the storage apparatus 100 (a local site) is remotely copied to the volume V4 in the storage apparatus 110 (a remote site). For example, the volume V1 is a business volume to be accessed from a business server.

At this time, to avoid deterioration in I/O performances for the volume V1, data of the volume V1 at some time point t (a time point t1 or t2, for example) is temporarily copied to a volume (the volume V2 or V3, for example) in the same storage apparatus 100, and then the data of the volume in the copy destination is transferred to the storage apparatus 110 (so called a cascade copy).

For example, when daily backup of the volume V1 is carried out, data of the volume V1 at a time point t, such as the time point t1, or “at 24 o′clock on Sunday,” or the time point t2, or “at 24 o′clock on Monday” is copied to the volume V2 or V3 in the same storage apparatus 100.

In addition, considering the capacity efficiency in the storage apparatus 110, it is assumed that only differential data between the volumes is stored when data is copied from one volume to another volume in the storage apparatus 110. As such a copying method to store only the differential data, a copying method called a Copy On Write (COW) is described as an example.

In the following description, a volume to be a copy source of a COW copy is expressed by “a volume in a COW copy source” and a volume to be a copy destination of the COW copy is expressed by “a volume in a COW copy destination.” In addition, a volume to be a copy source of a remote copy may be expressed by “a volume in a remote copy source” and a volume to be a copy destination of a remote copy may be expressed by “a volume in a remote copy destination.”

When the COW copy is carried out, data is not copied at some time point t but the data before update is copied to the volume in the COW copy destination if an update occurs in the volume in the COW copy source. After that, the update to the volume in the COW copy source is carried out. In short, only physical data of an updated portion is stored in the volume in the COW copy destination, and, thus, when there is an access to a portion other than the updated portion, the access is directed to the volume in the COW copy source.

Accordingly, when a remote copy is carried out by using the volume in the COW copy destination as a volume in the remote copy source, data of the portion other than the updated portion is read from the volume in the COW copy source and the data is transferred to the volume in the remote copy destination. In this manner, the remote copy may be carried out.

However, when data is copied from a volume (the volume V3, for example) in the second (second generation) COW copy destination to one volume (the volume V4, for example) in the remote site, there is a case where a copy destination of the remote copy is set as the copy destination of the remote copy which has started before that remote copy. In this case, since the copy destination of the remote copy which is newly started and the copy destination of the existing remote copy are duplicated, it becomes difficult to secure consistency of the data to be stored in the volume in the remote copy destination.

For example, it is assumed that the volume V2 in the COW copy destination in which data at the time point t1 is stored is synchronized with the volume V4 in the remote site by the remote copy. In this state, the remote copy is not newly started from the volume V3 in the COW copy destination in which data at the time point t2 is stored to the volume V4 in the same remote site.

To secure the data consistency, there may be a method of newly starting a remote copy after deleting the existing remote copy. In this case, however, the remote copy has to be started from the beginning. Accordingly, even when an amount of update to the volume in the COW copy source carried out during the execution of the COW copy is the smallest, the data copy has to be performed again on the entire volume. This results in increasing a data transfer amount and thus increasing copying time.

Also, to secure the data consistency, there may be a method of newly preparing a volume for a remote copy in a remote site. Even in this case, however, there is a disadvantage of performing the remote copy again from the beginning. Also, a volume whose size is equal to that of the COW copy source has to be created on the remote site side for each of the volumes in the COW copy destination. This results in increasing a data amount to be handled on the remote site side.

Accordingly, in the present embodiment, the description is given of a control method of suppressing a copying time when a remote copy is performed by using a volume in a COW copy destination as a volume in a remote copy source. Hereinafter, an example of control processing for the storage control device 101 is described by assuming a case where data of the volume V1 in the storage apparatus 100 at a time point t2 is remotely copied to the volume V4 in the storage apparatus 110.

Note that, it is also assumed that in the storage apparatus 100, a first generation COW copy in which the data of the volume V1 at the time point t1 is copied to the volume V2 has been started and a second generation COW copy in which the data of the volume V1 at the time point t2 after the time point t1 is copied to the volume V3 has been started. Moreover, it is assumed that the data of the volume V1 at the time point t1 has already been copied in the volume V4 in the storage apparatus 110. In short, it is assumed that the first remote copy has been completed.

(1) The storage control device 101 accepts a copy request from the volume V3 in the storage apparatus 100 to the volume V4 in the storage apparatus 110. This copy request is equivalent to a copy request for copying the data of the volume V1 at the time point t2 to the volume V4. Specifically, for example, the storage control device 101 accepts a copy request from a higher level device configured to control backup processing for the data of the volume V1.

(2) Based on correspondence information D stored in a storage unit 103, the storage control device 101 extracts data from the volume V3 in response to the acceptance of the copy request, the data corresponding to a storage region where a differential between the volume V1 and the volume V2 exists. It is noted here that the correspondence information D is information in which the volumes V1, V2, and V3 in the storage apparatus 100 are associated with one another.

The volume V1 is a volume in the COW copy source. The Volume V2 is a volume in the COW copy destination storing data of the volume V1 at the time point t1. The volume V3 is a volume in the COW copy destination storing data of the volume V1 at the time point t2. The storage unit 103 is realized by a memory of the storage control device 101, for example.

The storage region where a differential exists between the volume V1 and the volume V2 is a storage region where an update occurs after the time point t1 and corresponds to a storage region where a differential exits between the volume V2 and the volume V3. Similarly, a storage region where a differential exits between the volume V2 and the volume V3 corresponds to a storage region where a differential exits between the volume V3 (the volume V1 at the time point t2) and the volume V4.

In other words, the data corresponding to the storage region other than the storage region where a differential exits between the volume V1 and the volume V2 has already been stored in the volume V4. Accordingly, the storage control device 101 extracts the data corresponding to the storage region where a differential exits between the volume V1 and the volume V2 from the volume V3 as data to be copied.

It is noted, however, that only updated portions of physical data updated after the time point t2 are stored in the volume V3 in the remote copy source which is the COW copy destination. Accordingly, when the storage control device 101 extracts the data other than the updated portions from the volume V3, the data is read from the volume V1 in the COW copy source.

(3) The storage control device 101 transmits the extracted data to the storage apparatus 110. Specifically, for example, the storage control device 101 transmits the extracted data to the storage control device 111 in the storage apparatus 110. Accordingly, in the storage apparatus 110, the storage control device 111 stores the data in the volume V4 and copies the data of the volume V1 at the time point t2 to the volume V4.

It is noted that from viewpoints of portability and a cost, the data copied in the storage apparatus 110 in the remote site is copied to a tape device 120 having a magnetic tape 121. In this case, the volume V4 in the remote copy destination on the storage apparatus 110 in the remote site is a temporal storage destination until the data is copied to the tape device 120.

As described above, the storage control device 101 according to the present embodiment is able to extract data, from the volume V3, the data corresponding to the storage region where a differential exists between the volume V1 and the volume V2, in response to a copy request from the volume V3 to the volume V4. In addition, the storage control device 101 is capable of transmitting the extracted data to the storage apparatus 110.

Accordingly, the data corresponding to an update differential of the one generation earlier COW copy is extracted at the remote copy update, as a copy target, from the remote copy source which is the latest generation COW copy destination, so that copying time is suppressed in accordance with the time for an update differential amount of the one generation earlier COW copy. As a result, as compared with the case where data copy is started over again on the entire volume even when an update amount of the volume in the COW copy source is small, a data transfer amount between the storage apparatuses 100 and 110 is reduced to shorten the copying time.

An example of the storage control device 101 according to the present embodiment is described below. It is noted that the description of portions same as those described in the above embodiment is omitted.

(Exemplary System Configuration of System 200)

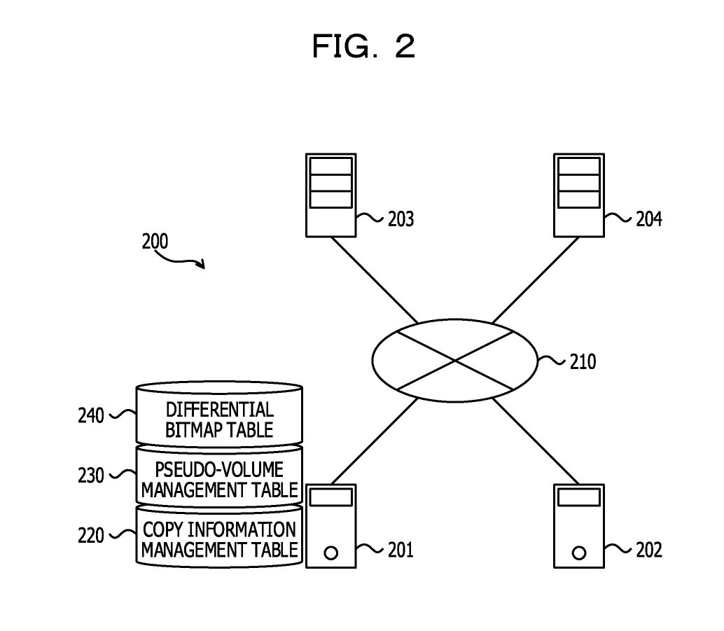

FIG. 2 is a diagram illustrating an exemplary system configuration of a system 200. In FIG. 2, the system 200 includes a storage apparatus 201, a storage apparatus 202, a business server 203, and a backup server 204. In the system 200, the storage apparatus 201, the storage apparatus 202, the business server 203, and the backup server 204 are connected through a wired or radio network 210. The network 210 may be a storage area network (SAN), a local area network (LAN), a wide area network (WAN), or the Internet, for example.

The storage apparatuses 201 and 202 are a computer configured to store data. For example, the storage apparatuses 201 and 202 are a redundant array of inexpensive disks (RAID) devices in which data to be stored and redundant data for failure recovery are stored in a dispersed manner in multiple hard disk drives.

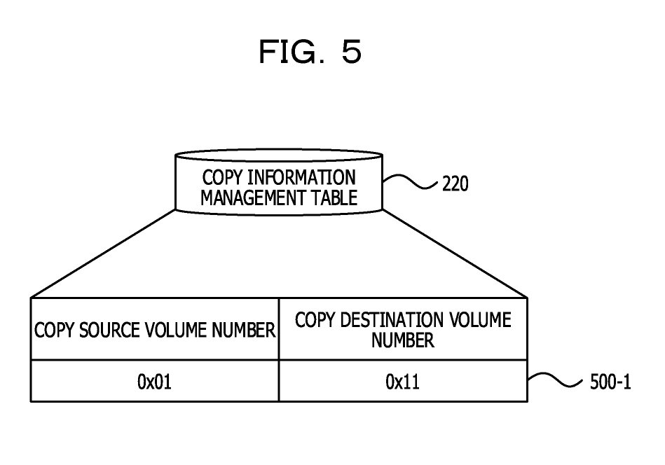

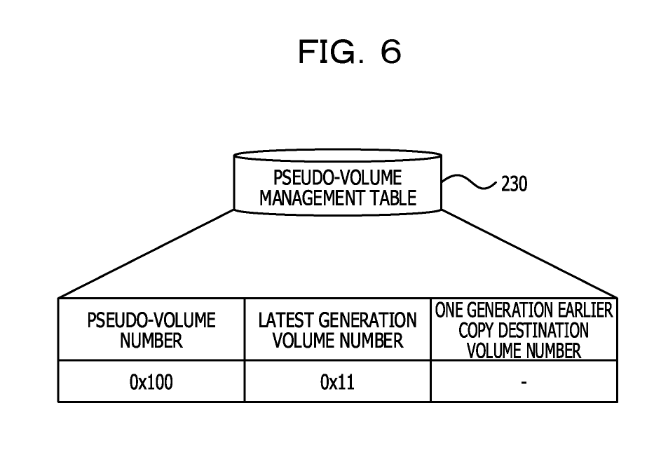

The storage apparatus 201 is a storage apparatus in a copy source, which includes a copy information management table 220, a pseudo-volume management table 230, and a differential bitmap table 240. Similarly, the storage apparatus 202 is a storage apparatus in a copy destination. The storage contents of the copy information management table 220 and the pseudo-volume management table 230 are described later by using FIGS. 5 and 6.

It is noted that the storage apparatuses 100 and 110 described in the embodiment respectively correspond to the storage apparatuses 201 and 202, for example. The correspondence information D described in the present embodiment corresponds to the pseudo-volume management table 230, for example.

The business server 203 is a computer in which a business application is installed and issues a WRITE request and a READ request to the storage apparatuses 201 and 202. The backup server 204 is a computer in which an application for backup is installed and controls a copy operation between the volumes in the storage apparatuses 201 and 202.

In the following description, the storage apparatus 201 in the copy source may be expressed by “a local site” and the storage apparatus 202 in the copy destination may be expressed by “a remote site.”

(Exemplary Device Configurations of Storage apparatuses 201 and 202)

Hereinafter, exemplary device configurations of the storage apparatuses 201 and 202 are described. Here, of the storage apparatuses 201 and 202, the storage apparatus 201 is described as an example.

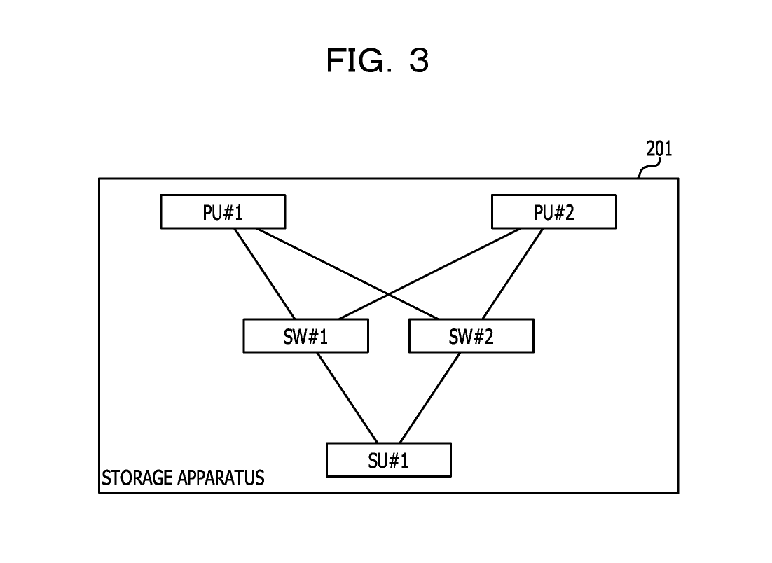

FIG. 3 is a diagram illustrating an exemplary device configuration of the storage apparatus 201. In FIG. 3, the storage apparatus 201 includes a processor unit (PU) #1, PU#2, a storage unit (SU) #1, and switches (SWs) #1 and #2.

The PU#1 and PU#2 are a computer configured to control the SU#1 and, as illustrated in FIG. 2, accept an access from the business server 203 to the SU#1 and process the accepted access. The PU#1 manages the PU#2 and functions as a master control unit configured to control the entire storage apparatus. The storage control device 101 described in the embodiment is equivalent to the PU#1, for example.

The SU#1 is a computer which includes a storage and is configured to control I/O processing on the storage. The storage includes at least one storage device. The storage device may be a physical storage device, such as a hard disk, an optical disk, a flash memory, or a magnetic tape or may be an LUN which is a logical storage device. For example, in the SU#1, a RAID group is formed to integrate multiple storage devices into one storage device. The storage device 102 described in the embodiment is equivalent to the SU#1, for example.

The SW#1 and the SW#2 are a computer having a switching function. The SW#1 and the SW#2 relay data by selecting a path (port) corresponding to an address of the received data. In the storage apparatus 201, for example, a full mesh connection is established between the PU#1 and PU#2 and the SU#1 through the redundant SW#1 and SW#2.

It is noted that FIG. 3 depicts a case where the storage apparatus 201 includes two PUs as an example. However, the storage apparatus 201 may include any number of PUs as long as the number is equal to or bigger than one.

(Exemplary Hardware Configuration of PU or the like)

Hereinafter, described is an exemplary hardware configuration of PU, SU, SW or the like (hereinafter, only referred to as “PU or the like”).

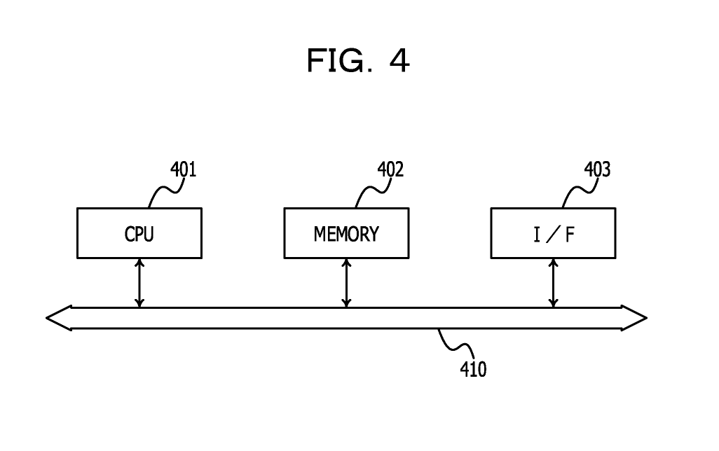

FIG. 4 is a block diagram illustrating an exemplary hardware configuration of a PU or the like. In FIG. 4, the PU or the like includes a central processing unit (CPU) 401, a memory 402, and an interface (I/F) 403. In addition, each of the configuration units is connected with a bus 410.

The CPU 401 performs entire control over the PU or the like. For example, the memory 402 includes a read only memory (ROM), a random access memory (RAM), and a flash ROM. More specifically, the flash ROM stores an OS and programs such as firmware, the ROM stores application programs, and the RAM is used as a work area for the CPU 401. When the program stored in the memory 402 is loaded to the CPU 401, the program causes the CPU 401 to execute coded processing.

The I/F 403 controls a data input from or a data output to other computers. Specifically, the I/F 403 is connected with a network 210 through a communication line and, through this network 210, is connected with other computers. Further, the I/F 403 functions as an interface between the network and inside to control a data input from or a data output to other computers.

(Contents Stored in Copy Information Management Table 220)

Hereinafter, the description is given of contents stored in the copy information management table 220 included in the storage apparatus 201 in the copy source. The copy information management table 220 is stored in the memory 402 of the PU#1 in FIG. 4, for example.

FIG. 5 is a diagram illustrating exemplary contents stored in the copy information management table 220. In FIG. 5, the copy information management table 220 has fields of a copy source volume number and a copy destination volume number. When information is set to each of the fields, copy information (copy information 500-1, for example) is stored as a record.

It is noted here that the copy source volume number is information (such as a device identifier, a LUNV number, a start position) to identify a volume in the copy source. In addition, the copy destination volume number is information to identify a volume in the copy destination. For example, the copy information 500-1 indicates a copy source volume number “0x01” and a copy destination volume number “0x11.”

Note that, although the illustration is omitted, the copy information management table 220 stores, in addition to the copy source volume number and the copy destination volume number, a copy size and address information of the differential bitmap table 240 as copy information.

(Contents Stored in Pseudo-Volume Management Table 230)

Hereinafter, the description is given of contents stored in the pseudo-volume management table 230 included in the storage apparatus 201 in the copy source. The pseudo-volume management table 230 is stored in the memory 402 of the PU#1 in FIG. 4, for example.

FIG. 6 is a diagram illustrating exemplary contents stored in the pseudo-volume management table 230. In FIG. 6, the pseudo-volume management table 230 stores a pseudo-volume number, a latest generation volume number, and a one generation earlier copy destination volume number in association with one another.

Here, the pseudo-volume number is information (a LUNV number, for example) to identify a pseudo-volume. The pseudo-volume is one pseudo-volume which is defined for one volume in the COW copy source. The pseudo-volume is not substantial and is defined as a link to the volume in the latest COW copy destination.

As described above, the COW copy means a copy of Copy-On-Write. In the case of the COW copy, when a COW copy request for some data occurs, the data copy is not immediately carried out, but original data is referred to as copy data, and then the data copy is executed after a free space is secured at the time point when data update (write) occurs.

The latest generation volume number is information (such as a LUNV number, a start position, or a size) to identify a volume in the latest COW copy destination. The one generation earlier copy destination volume number is information (such as LUNV number, a start position, or a size) to identify a volume in the one generation earlier COW copy destination. Note that the information such as the start position or size of the volume is not illustrated herein.

In the example of FIG. 6, the pseudo-volume management table 230 indicates a correspondence relationship among the pseudo-volume number “0x100,” the latest generation volume number “0x11,” and the one generation earlier copy destination volume number “−(NULL).” However, since the volume in the latest COW copy destination is a first generation volume, the one generation earlier copy destination volume number is set as “−.”

(Exemplary Update of Differential Bitmap Table 240)

Hereinafter, an exemplary update of the differential bitmap table 240 is described. First, the description is given of an exemplary update of the differential bitmap table 240 in a case where the COW copy is performed between the volumes.

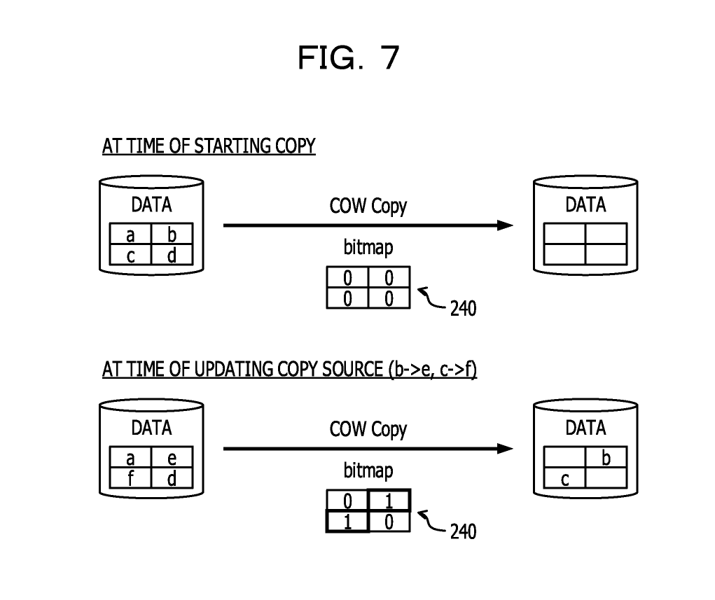

FIG. 7 is a diagram (No. 1) illustrating an exemplary update of the differential bitmap table 240. In FIG. 7, the differential bitmap table 240 indicates a differential bitmap for each of sections in which a copy target region (a copy source volume) is divided by some size unit. The differential bitmap is information for one bit and expresses an existence of a differential between the volumes in each section.

The unit size to divide the copy target region may be randomly changed by settings of the storage apparatus 201, for example. In the case of the COW copy, a differential bit of each section is set to “0” at the time of starting copy. The differential bit of each section is set to “1” at the time when a WRITE request for any region in one section in the copy source is made and saving of the source data to the section in the copy destination completes.

For ease of the description, a case where a copy target region is divided into four sections is described as an example. Note that there may be a case where a differential bit on the upper left of the differential bitmap table 240 is expressed as a differential bit for section 1, a differential bit on the upper right is expressed as a differential bit for section 2, a differential bit on the lower left is expressed as a differential bit for section 3, and a differential bit on the lower right is expressed as a differential bit for section 4.

In the example of FIG. 7, data b in the section 2 in the copy source is updated to data e and the data b is saved in the section 2 in the copy destination. Accordingly, the differential bit in the section 2 is changed to “1.” Similarly, data c in the section 3 in the copy source is updated to data f and the data C is saved in the section 3 in the copy destination. Accordingly, the differential bit in the section 3 is changed to “1.”

Next, the description is given of an exemplary update of the differential bitmap table 240 in the case where the remote copy is performed between the volumes.

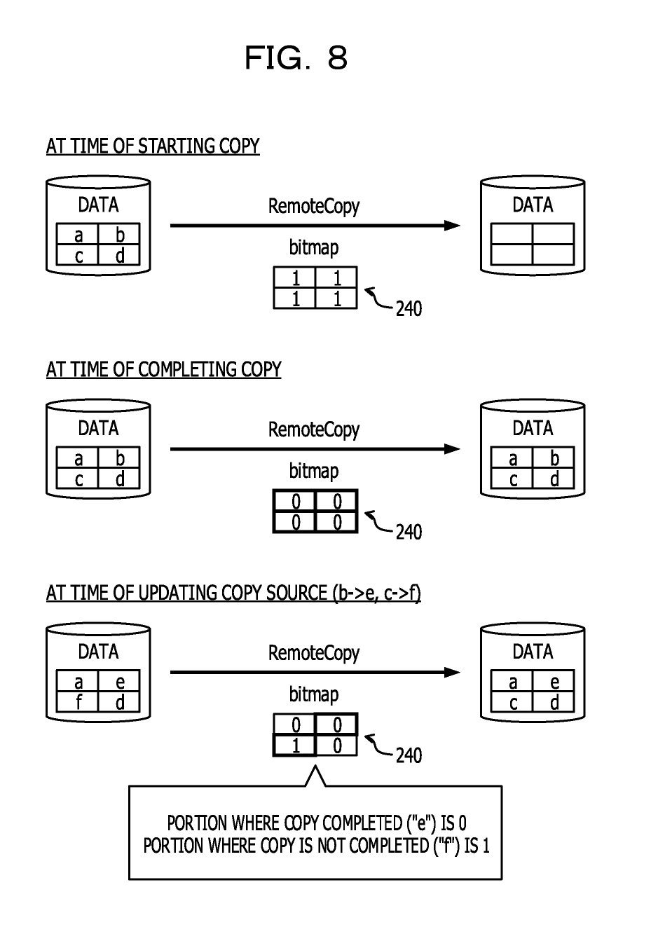

FIG. 8 is a diagram (No. 2) illustrating an exemplary update of the differential bitmap table 240. In the case of the remote copy, a differential bit in one section in the copy source is set to “1” at the time of initial copy or at the time when a WRITE request for any region in the section in the copy source exits and a differential occurs. Also, a differential bit in the section is set to “0” at the time when storing source data in the section in the copy destination is completed.

In the example of FIG. 8 (at the time when copy is completed), since data a to data d in the sections 1 to 4 in the copy source are stored in the sections 1 to 4 in the copy destination, the differential bits in the sections 1 to 4 are changed to “0.”

In the example of FIG. 8 (at the time of updating the copy source), the data e is stored in the section 2 in the copy destination after the data b in the section 2 in the copy source is updated to the data e. Accordingly, the differential bit in the second section is changed to “0.” On the other hand, the data f is not stored in the section 3 in the copy destination after the data c in the section 3 in the copy source is updated to the data f. Accordingly, the differential bit in the section 3 remains in “1.”

(Exemplary Functional Configuration of PU#1)

Next, an exemplary functional configuration of the PU#1 of the storage apparatus 201 is described.

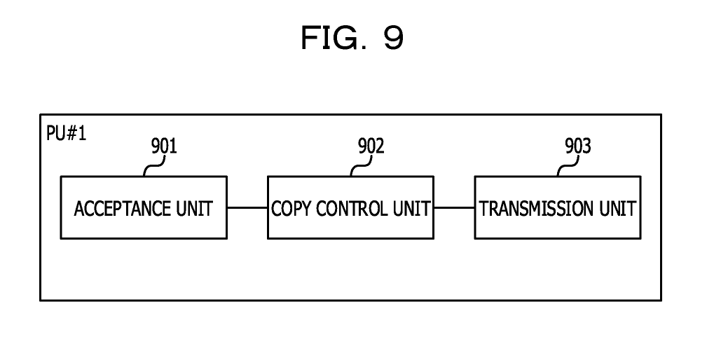

FIG. 9 is a block diagram illustrating an exemplary functional configuration of the PU#1. In FIG. 9, the PU#1 has a configuration including an acceptance unit 901, a copy control unit 902, and a transmission unit 903. The acceptance unit 901, the copy control unit 902, and the transmission unit 903 are functions as control units. Specifically, for example, these functions are realized by causing the CPU 401 to execute a program stored in the memory 402 of the PU#1 or by the I/F 403 in FIG. 4. Processing results of the functional units are stored in the memory 402, for example.

The acceptance unit 901 has a function to accept a COW copy request from the backup server 204. The COW copy request is a request for starting a COW copy between the volumes in the storage apparatus 201. The COW copy request includes information (a volume number, for example) to identify a volume in the COW copy source and a volume in the COW copy destination.

The copy control unit 902 has a function to start the COW copy between the volumes designated by the COW copy request in response to the acceptance of the COW copy request. For example, the copy control unit 902 first secures a memory region in the memory 402 for the differential bit map table of the COP copy.

Then, the copy control unit 902 refers to the COW copy request and sets a copy source volume number and a copy destination volume number in the respective fields in the copy information management table 220. After that, the copy control unit 902 starts monitoring the WRITE request for the COW copy source volume.

Also, the copy control unit 902 has a function to create a pseudo-volume corresponding to the volume in the COW copy source. For example, the copy control unit 902 first refers to the pseudo-volume management table 230 to determine if a pseudo-volume corresponding to the volume in the COW copy source is defined.

When the pseudo-volume has not been defined yet, the copy control unit 902 defines a pseudo-volume number capable of uniquely identifying the pseudo-volume corresponding to the volume in the COW copy source. After that, the copy control unit 902 sets a pseudo-volume number, a latest generation volume number, and one generation earlier copy destination volume number in the corresponding fields of the pseudo-volume management table 230. The latest generation volume number is a volume number of the volume in the COW copy destination. The one generation earlier copy destination volume number does not exist when the pseudo-volume has not been defied.

On the other hand, when the pseudo-volume has been defined, the copy control unit 902 sets a latest generation volume number of the pseudo-volume management table 230 as the one generation earlier copy destination volume number. After that, the copy control unit 902 sets the volume number of the volume in the COW copy destination as the latest generation volume number.

The transmission unit 903 has a function to transmit a COW copy response to the backup server 204. The COW copy response is to notify start of the requested COW copy. The COW copy response includes a pseudo-volume number capable of uniquely identifying the pseudo-volume corresponding to the volume in the COW copy source.

The acceptance unit 901 has a function to accept a WRITE request for the volume in the COW copy source from the business server 203. The WRITE request includes data to perform writing on any storage region (a block) in the volume in the COW copy source.

The copy control unit 902 has a function to execute the WRITE processing in response to the acceptance of the WRITE request. For example, the copy control unit 902 first acquires, from the copy information management table 220, copy information in which the volume number of the volume in the COW copy source is set as the copy source volume number.

After that, the copy control unit 902 refers to address information of the differential bitmap table 240 of the acquired copy information to acquire the differential bitmap table 240 from the memory 402. Then, the copy control unit 902 refers to the acquired differential bitmap table 240 to specify the differential bit in a target section of the WRITE request.

When the differential bit is “0” here, data has not been saved. Thus, the copy control unit 902 save the data of the block of the volume in the COW copy source in the volume in the COW copy destination and changes the differential bit in the target section to “1.” After that, the copy control unit 902 executes the requested WRITE processing. On the other hand, when the differential bit is “1,” the data has already been saved. Accordingly, the copy control unit 902 does not save the data and executes the requested WRITE processing.

The transmission unit 903 has a function to transmit a WRITE response to the business server 203. The WRITE response here is to notify the completion of the requested WRITE processing.

The acceptance unit 901 has a function to accept a remote copy request from the backup server 204. The remote copy request here is to request for starting the remote copy between the volumes of the storage apparatuses 201 and 202. The remote copy request includes information to identify the volume in the remote copy source and the volume in the remote copy destination.

For example, the information to identify the volume in the remote copy source includes a pseudo-volume number of the pseudo-volume corresponding to the volume in the COW copy source. Also, the information to identify the volume in the remote copy destination includes a volume number of the volume in the remote copy destination, for example.

The copy control unit 902 has a function to start remote copy between the volumes designated by the remote copy request in response to the acceptance of the remote copy request. For example, the copy control unit 902 first refers to the pseudo-volume management table 230 to determine if the volume in the remote copy source is the pseudo-volume.

When it is not the pseudo-volume, the copy control unit 902 starts the remote copy between the volumes designated by the remote copy request. On the other hand, when it is the pseudo-volume, the copy control unit 902 refers to the copy information management table 220 to determine if the existing remote copy has already existed.

The existing remote copy is a remote copy in which the latest generation volume is used as a volume in the remote copy source and the volume in the copy destination designated by the remote copy request is used as the volume in the remote copy destination. When the existing remote copy does not exist, the copy control unit 902 starts the remote copy between the volumes designated by the remote copy request.

On the other hand, when the existing remote copy does exist, the copy control unit 902 acquires the differential bitmap table 240 of the existing remote copy. Then, the copy control unit 902 determines if all pieces of the data are copied (all the differential bits are “0”). When all pieces of the data have not been copied, the copy control unit 902 awaits until all pieces of the data are copied.

When all pieces of the data are copied, the copy control unit 902 refers to the pseudo-volume management table 230 to acquires, from the copy information management table 220, the copy information of the COW copy in which the one generation earlier copy destination volume is used as the volume in the COW copy destination. Next, the copy control unit 902 refers to the acquired copy information to acquire the differential bitmap table 240 of the COW copy.

Thereafter, the copy control unit 902 copies the acquired differential bitmap table 240 and creates the differential bitmap table 240 for differential reflection of the remote copy. Then, the copy control unit 902 deletes the existing remote copy by deleting the copy information of the existing remote copy from the copy information management table 220.

The copy control unit 902 refers to the created differential bitmap table 240 for differential reflection to start the remote copy between the volumes designated by the remote copy request. Specifically, for example, the copy control unit 902 refers to the differential bitmap table 240 for differential reflection to specify one section whose differential exists, in other words, one section whose differential bit is “1.” After that, data transfer for the specified section is performed. Then, the copy control unit 902 changes the differential bit to “0” with regard to the section whose data transfer is completed.

In addition, when the remote copy is activated normally, the copy control unit 902 records the copy information of the remote copy in the copy information management table 220.

The transmission unit 903 has a function to transmit a remote copy response to the backup server 204. The remote copy response here is to notify the start of the requested remote copy.

The acceptance unit 901 has a function to accept a COW copy stop request from the backup server 204. The COW copy stop request here is to request for stopping the COW copy between the volumes in the storage apparatus 201. The COW copy stop request includes information (a volume number, for example) identifying a volume in the COW copy source and a volume in the COW copy destination.

The copy control unit 902 has a function to stop the COW copy between the volumes designated by the COW copy stop request in response to the acceptance of the COW copy stop request. For example, the copy control unit 902 first refers to the pseudo-volume management table 230 to determine if the volume in the COW copy destination of the COW copy designated by the COW copy stop request has been set as the latest generation volume.

When it has not been set as the latest generation volume, the copy control unit 902 stops the COW copy between the volumes designated by the COW copy stop request. On the other hand, when it has been designated as the latest generation volume, the copy control unit 902 refers to the pseudo-volume management table 230 to determine if the one generation earlier copy destination volume number has been set.

When the one generation earlier copy destination volume number has not been set, the copy control unit 902 deletes the information (the corresponding pseudo-volume information) in the pseudo-volume management table 230. After that, the copy control unit 902 stops the COW copy between the volumes designated by the COW copy stop request.

On the other hand, when the one generation earlier copy destination volume number has been set, the copy control unit 902 refers to the copy information management table 220 to determines if there is the copy information of the COW copy in which the one generation earlier volume is used as the COW copy destination volume.

When the copy information does not exist, the copy control unit 902 deletes the information (the corresponding pseudo-volume information) in the pseudo-volume management table 230. After that, the copy control unit 902 stops the COW copy between the volumes designated by the COW copy stop request.

On the other hand, when the copy information exists, the copy control unit 902 updates the latest generation volume number in the pseudo-volume management table 230 by the one generation earlier copy destination volume number and sets “−” to the one generation earlier copy destination volume number. After that, the copy control unit 902 stops the COW copy between the volumes designated by the COW copy stop request.

In addition, when the COW copy is normally stopped, the copy control unit 902 releases the memory region for the differential bitmap table of the stopped COW copy. After that, the copy control unit 902 deletes the copy information of the stopped COW copy from the copy information management table 220.

The transmission unit 903 has a function to transmit a COW copy stop response to the backup server 204. The COW copy stop response here is to notify the stop request of the requested COW copy.

(Exemplary Control Processing of Storage Apparatus 201)

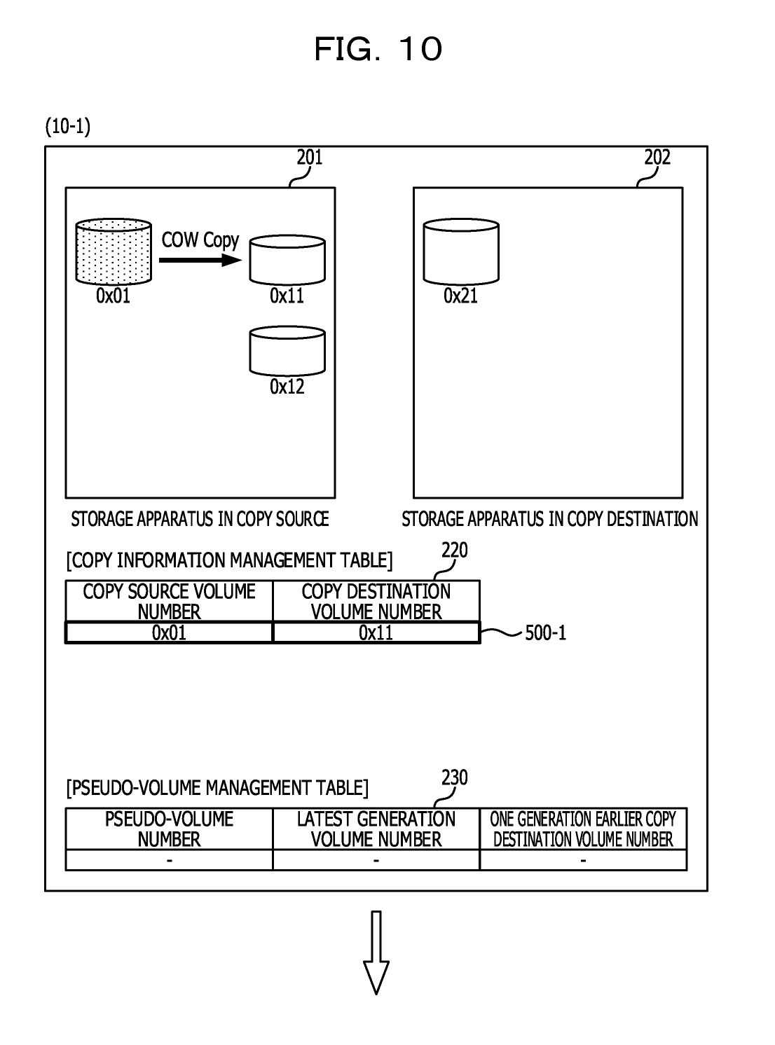

Hereinafter, control processing of the storage apparatus 201 using the pseudo-volume is described by referring to FIGS. 10 to 15.

FIGS. 10 to 15 are diagrams illustrating exemplary control processing of the storage apparatus 201. In response to the acceptance of the COW copy request from the backup server 204, a (10-1) PU#1 starts the COW copy between the volumes in the storage apparatus 201 (see FIG. 10).

It is assumed here that the volume number of the volume in the COW copy source is “0x01” and the volume number of the volume in the COW copy destination is “0x11.” In this case, the PU#1 sets the copy source volume number “0x01” and the copy destination volume number “0x11” to the corresponding fields in the copy information management table 220. Accordingly, copy information 500-1 is stored in the copy information management table 220 as a record.

After that, when a WRITE request for the volume in the COW copy source is made, the PU#1 first copies the source data in the volume in the COW copy destination and then writes the data in the volume in the COW copy source. In addition, the PU#1 records differential information of the executed copy in the differential bitmap table 240 (update of the differential bit).

Note that in the following description, the volume of the volume number “0xXX” may be expressed by “a volume (0xXX).”

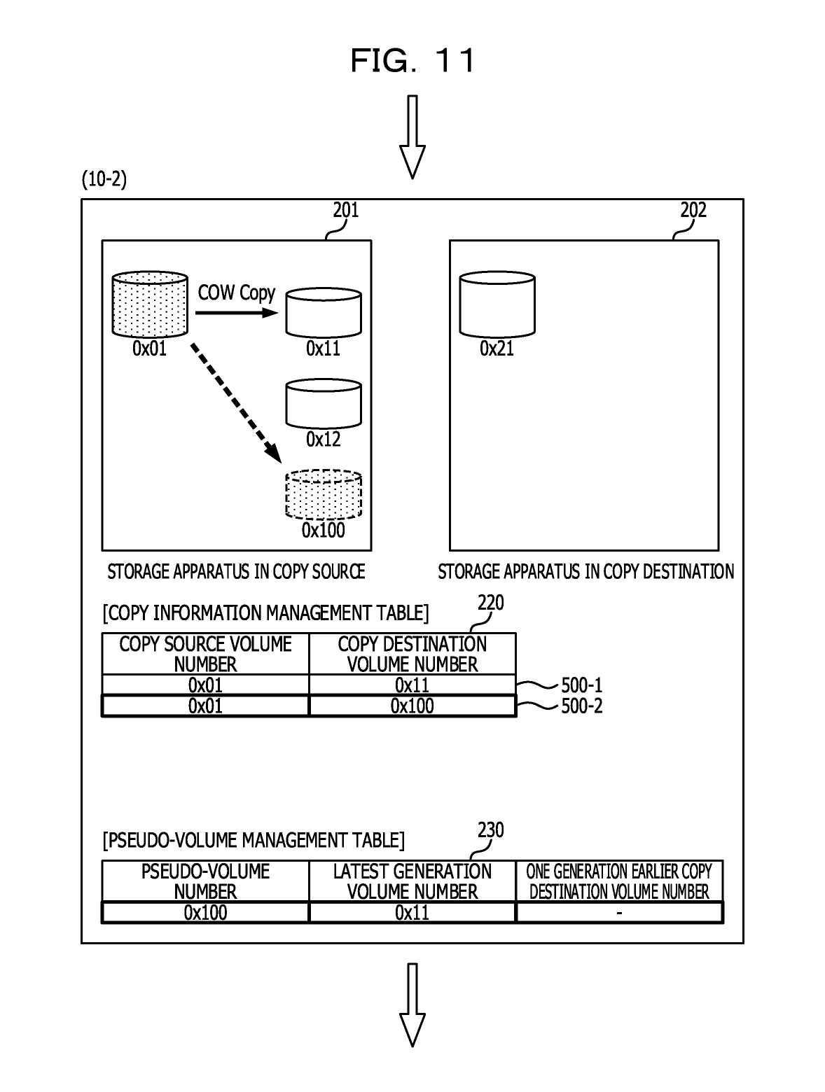

After the COW copy is started, a (10-2) PU#1 creates and updates a pseudo-volume for the volume in the COW copy source (see FIG. 11). For example, the PU#1 refers to the copy information management table 220 and the pseudo-volume management table 230 to determine if a pseudo-volume for the volume (0x01) in the COW copy source exists.

When the pseudo-volume does not exist, the PU#1 creates a pseudo-volume (0x100) for the volume (0x01) in the COW copy source. In this case, the PU#1 sets the copy source volume number “0x01” and the copy destination volume number “0x100” in the corresponding fields of the copy information management table 220. Accordingly, copy information 500-2 is stored as a record in the copy information management table 220.

In addition, the PU#1 stores the pseudo-volume number “0x100”, the latest generation volume number “0x11”, and the one generation earlier copy destination volume number “−” in association with one another in the pseudo-volume management table 230.

Also, the PU#1 transmits a COW copy response to the backup server 204. As described above, the COW copy response is to notify that the COW copy is successfully started in response to the COW copy request from the backup server 204. The COW copy response includes the volume number “0x100” of the pseudo-volume.

After that, the backup server 204 designates the volume number “0x100” of the pseudo-volume as a volume number in the remote copy source when the remote copy of the volume (0x01) is performed between the storage apparatuses 201 and 202.

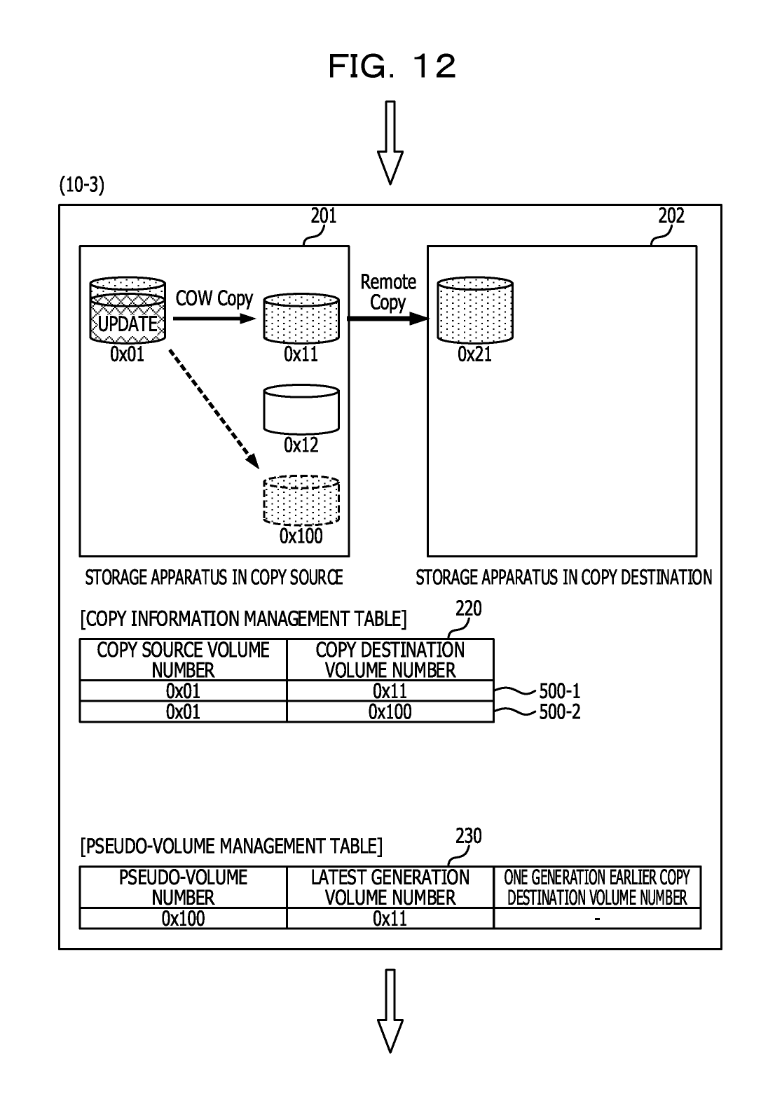

In response to the acceptance of the remote copy request (a start request) from the backup server 204, a (10-3) PU#1 starts the remote copy to the storage apparatus 202 in the copy destination (see FIG. 12). It is assumed here that the volume number of the volume in the remote copy source is “0x100” and the volume number of the volume in the remote copy destination is “0x21.”

Specifically, for example, the PU#1 refers to the pseudo-volume management table 230 to execute the remote copy to the volume (0x21) in the remote copy destination by using the volume (0x11) specified by the latest generation volume number as the volume in the remote copy source.

At this time, the PU#1 acquires differential information (a differential bit) from the differential bitmap table 240 of the volume (0x01) in the COW copy source and the volume (0x11) in the COW copy destination. Then, the PU#1 reads the data from the volume (0x11) in the COW copy destination for updated portion and the data from the volume (0x01) in the COW copy source for a portion other than the updated portion and transfers the read data to the storage apparatus 202.

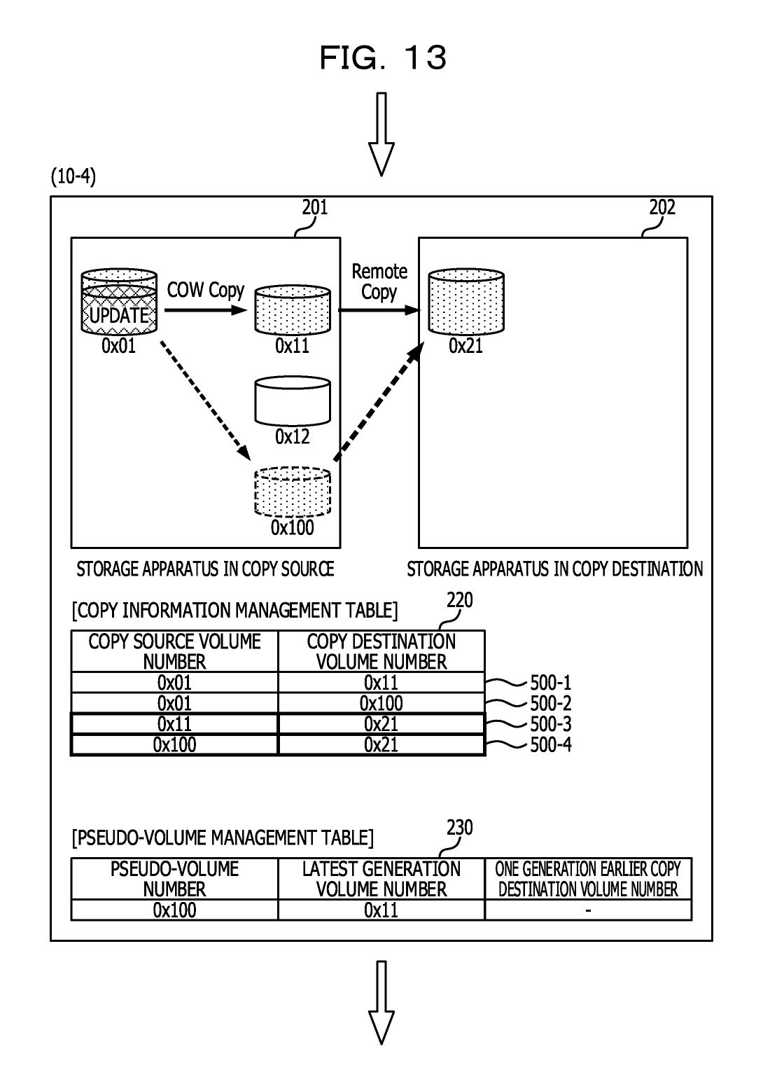

After the remote copy processing is started, a (10-4) PU#1 sets the copy source volume number “0x11” and the copy destination volume number “0x21” in the respective fields of the copy information management table 220 (see FIG. 13). Accordingly, copy information 500-3 is stored in the copy information management table 220 as a record.

Furthermore, the PU#1 sets the copy source volume number “0x100” and the copy destination volume number “0x21” in the respective fields of the copy information management table 220. Accordingly, copy information 500-4 is stored in the copy information management table 220 as a record.

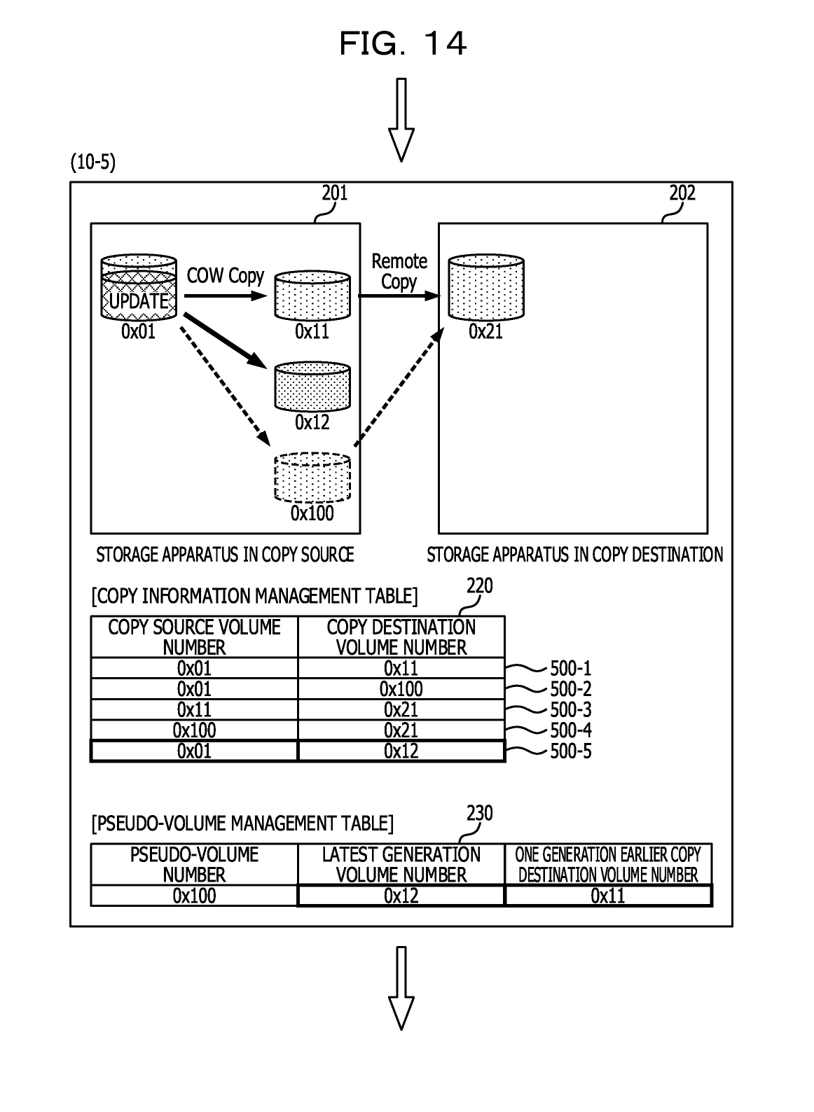

In response to the acceptance of the COW copy request from the backup server 204, a (10-5) PU#1 starts second generation COW copy (see FIG. 14). It is assumed here that the volume number of the volume in the COW copy source is “0x01” and the volume number of the volume in the COW copy destination is “0x12.”

In this case, the PU#1 sets the copy source volume number “0x01” and the copy destination volume number “0x12” in the respective fields of the copy information management table 220. Accordingly, copy information 500-5 is stored in the copy management table 220 as a record.

Also, the PU#1 refers to the copy information management table 220 and the pseudo-volume management table 230 to determine if the pseudo-volume for the volume (0x01) in the COW copy source exists.

When the pseudo-volume exists, the PU#1 updates the pseudo-volume management table 230. Specifically, for example, the PU#1 updates the latest generation volume number of the pseudo-volume management table 230 to “0x12” and the one generation earlier copy destination volume number to “0x11.”

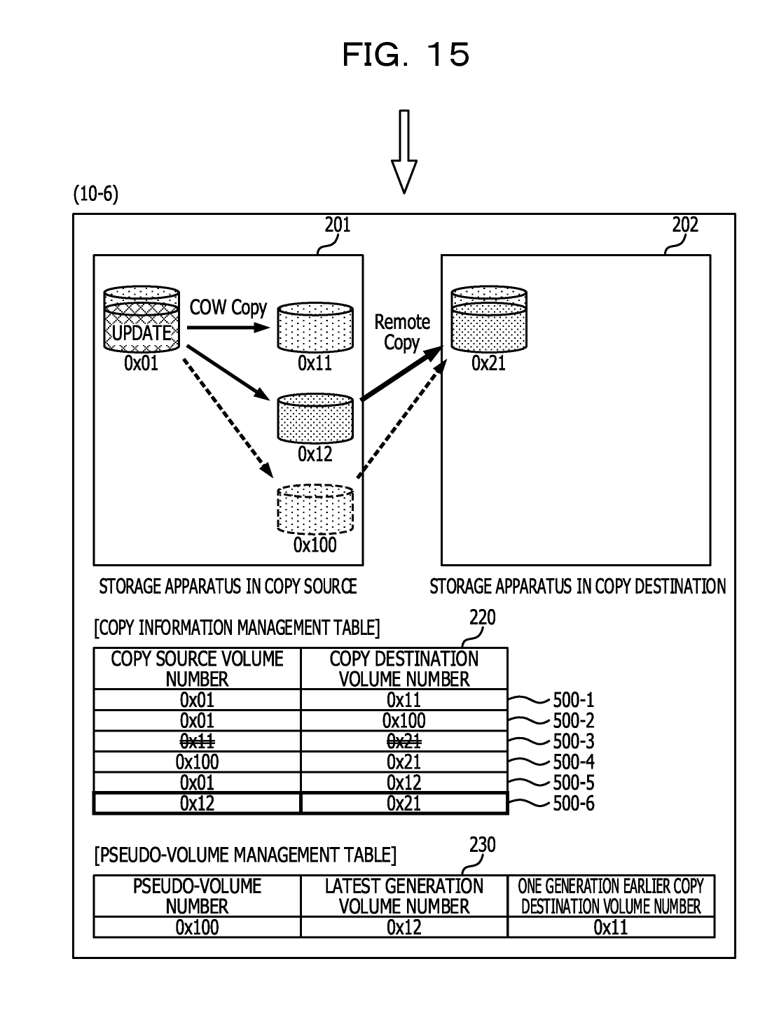

In response to the acceptance of the remote copy request (an update request) from the backup server 204, a (10-6) PU#1 refers to the pseudo-volume management table 230 to specify the one generation earlier copy destination volume number “0x11” (see FIG. 15). Next, the PU#1 deletes the copy information 500-3 of the remote copy whose copy source is the volume (0x11) of the one generation earlier copy destination volume number from the copy information management table 220.

After that, the PU#1 refers to the pseudo-volume management table 230 and starts the remote copy of the volume (0x12) specified from the latest generation volume number as the volume in the remote copy source to the volume (0x21) in the remote copy destination. At this time, the PU#1 refers to an update differential between the COW copy source volume (0x01) and the volume (0x11) in the one generation earlier COW copy destination and manages only the updated portion as a copy target of the remote copy.

In addition, the PU#1 sets the copy source volume number “0x12” and the copy destination volume number “0x21” in the respective fields of the copy information management table 220. Accordingly, copy information 500-6 is stored in the copy information management table 220 as a record.

When a new COW copy request is made later for the volume (0x01) in the same COW copy source, the same processing as the (10-5) processing is carried out. When a new remote copy request (an update request) is made, the same processing as the (10-6) processing is carried out.

In this manner, a physical copy at the time of the remote copy update, which is a cascade from the COW copy destination, may be shortened to a time according to a differential amount of updating the volume in the COW copy source. When the latest generation remote copy is executed, switching processing of the remote copy is carried out on the storage apparatus side. Therefore, the switching operation by the backup server 204 and a user becomes unnecessary. Only thing to do is to make an update instruction of the remote copy by designating the same remote copy source volume and the same remote copy destination volume at all times. As a result, a user operability becomes easier.

(Exemplary Differential Reflection of Remote Copy)

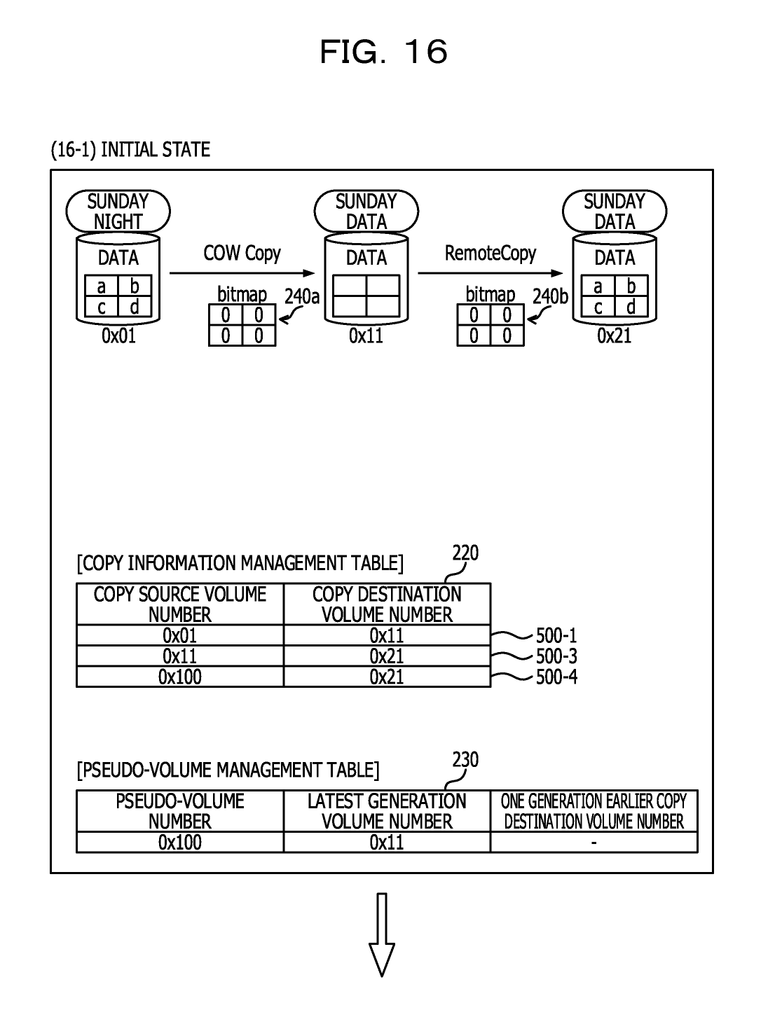

Hereinafter, an exemplary differential reflection of the remote copy is described by referring to FIGS. 16 to 21.

FIGS. 16 to 21 are diagrams illustrating an exemplary differential reflection of the remote copy. In (16-1) in FIG. 16, the COW copy between the volume (0x01) and the volume (0x11) is completed and the remote copy between the volume (0x1) and the volume (0x21) is completed.

The volume (0x01) is a volume in the COW copy source and stores data at the Sunday night. The volume (0x11) is a volume in the first generation COW copy destination and stores data on Sunday. It is noted, however, that the volume (0x11) is empty.

Also, the volume (0x11) is a volume in the remote copy source. The volume (0x21) is a volume in the remote copy destination and stores data on Sunday after the remote copy is completed. However, the remote copy is carried out assuming that the volume number “0x100” of the pseudo-volume is designated as the volume number in the remote copy source (0x100=>0x21).

A differential bitmap table 240a denotes an existence of a differential for each of the sections between the volume (0x01) and the volume (0x11). Similarly, a differential bitmap table 240bdenotes an existence of a differential for each of the sections between the volume (0x11) and the volume (0x21).

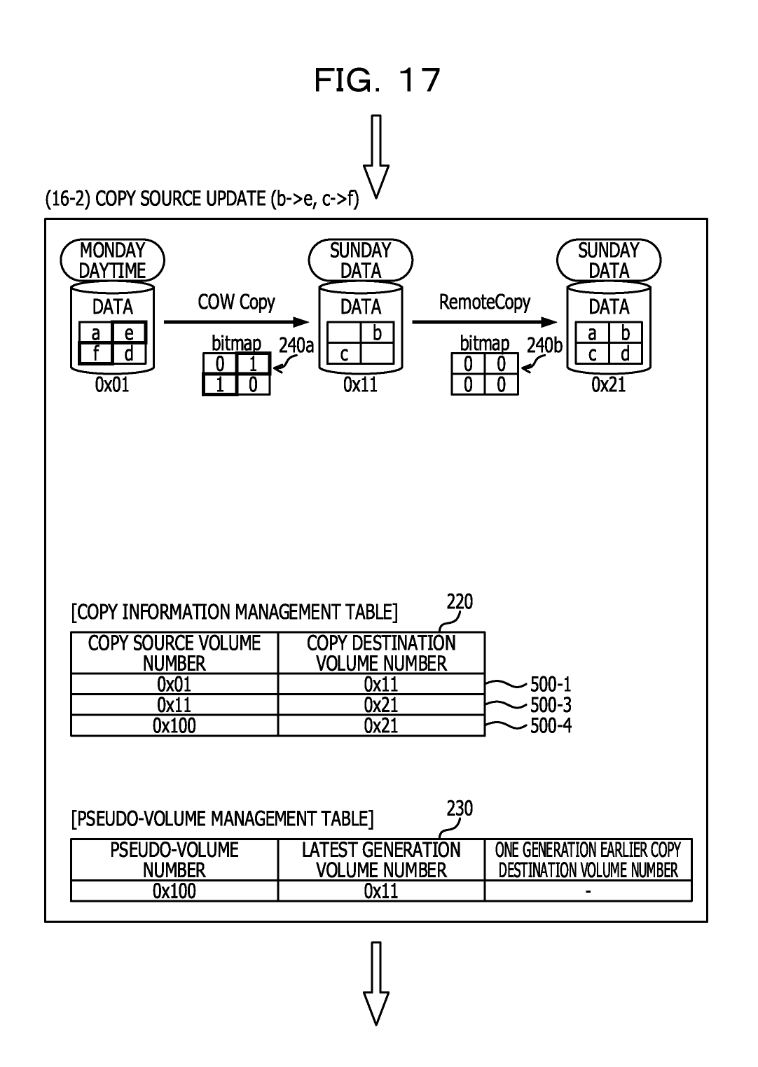

In (16-2) in FIG. 17, at the daytime on Monday, the data b in the section 2 of the volume (0x01) is updated to data e and the data c in the section 3 of the volume (0x01) is updated to data f. In this case, the PU#1 changes the differential bit in the section 2 of the differential bitmap table 240a to “1” and the differential bit in the section 3 to “1.”

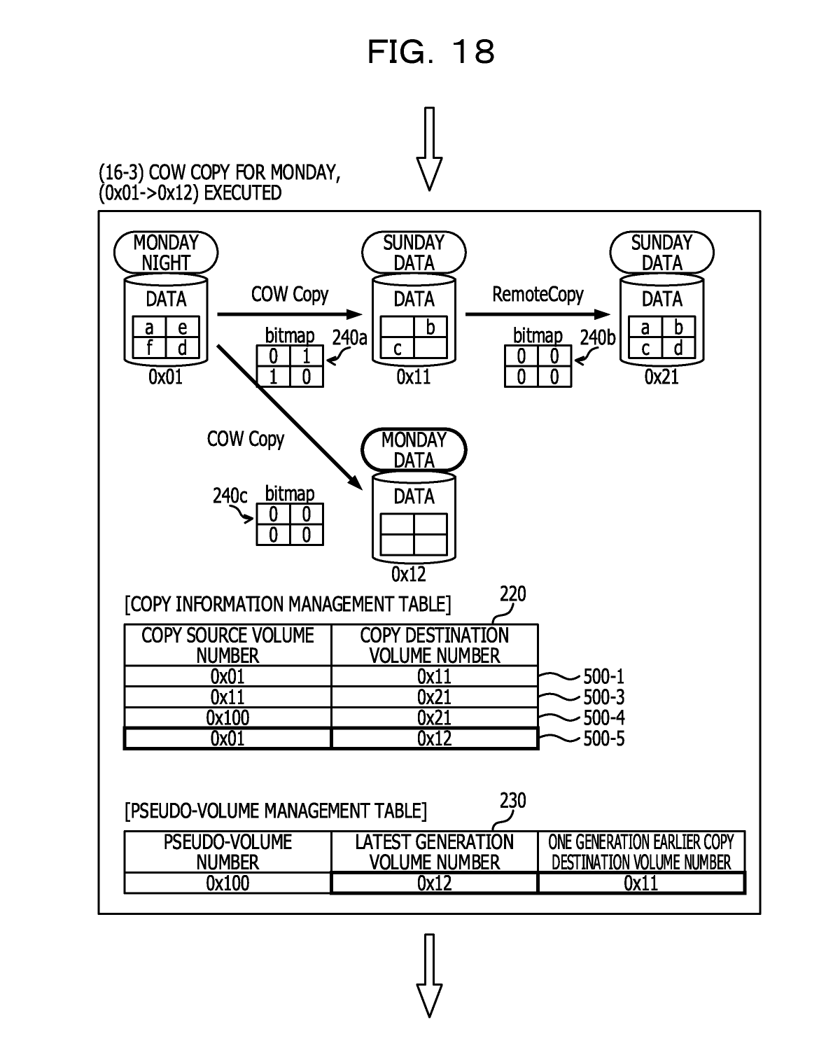

In (16-3) in FIG. 18, at the Monday night, in response to the acceptance of the COW copy request (0x01=>0x12) for Monday, the COW copy is carried out between the volume (0x01) and the volume (0x12). The volume (0x01) means here the volume in the COW copy source and stores data at the time point of the Monday night.

The volume (0x12) is a volume in the second generation COW copy destination and stores data on Monday. However, the volume (0x12) is empty at this time point. A differential bitmap table 240c denotes an existence of a differential for each of the sections between the volume (0x01) and the volume (0x12).

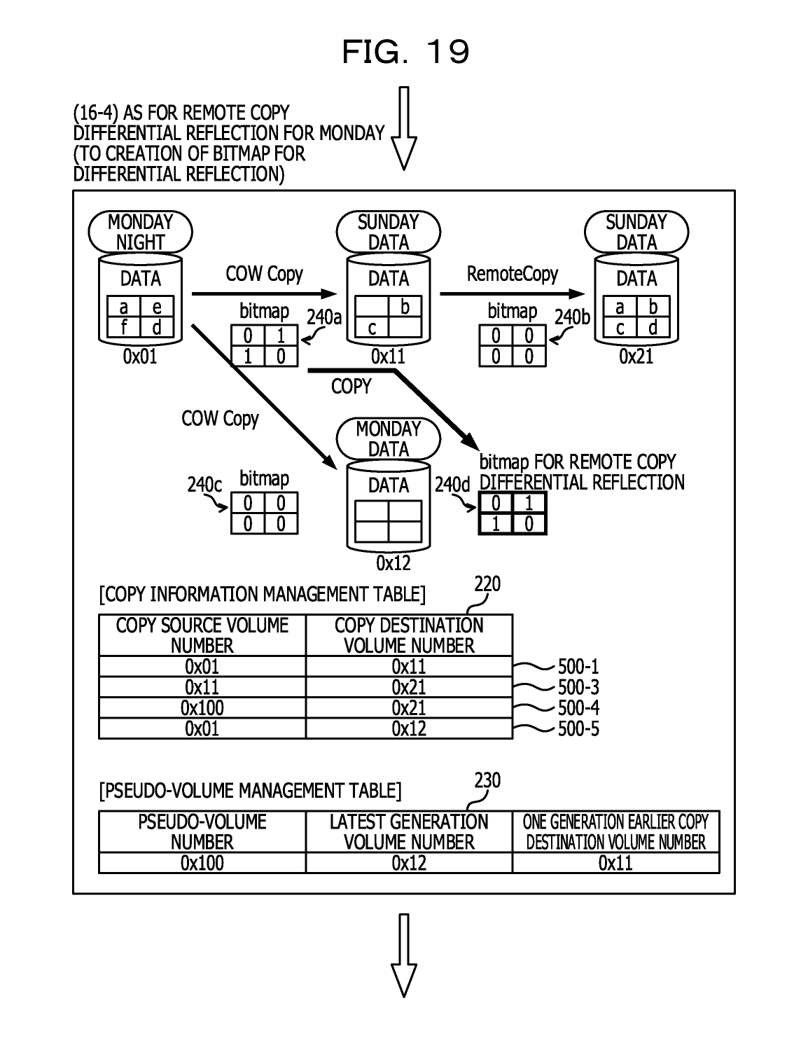

It is assumed that in (16-4) in FIG. 19, at the Monday night, a remote copy request (an update request) is accepted from the backup server 204. In this case, the PU#1 refers to the pseudo-volume management table 230 to specify the volume (0x11) in the one generation earlier COW copy destination.

Then, the PU#1 refers to the copy information management table 220 to determine if the existing remote copy from volume (0x11) in the one generation earlier COW copy destination to the volume (0x21) in the designated remote copy destination (0x11=>0x21) exits.

If the existing remote copy (0x11=>0x21) exists, the PU#1 refers to the differential bitmap table 240b to determine if all pieces of the data of the existing remote copy (0x11=>0x21) have been completely transferred (all differential bits are 0).

When all pieces of the data have been completely transferred, the PU#1 retrieves, from the copy information management table 220, the copy information 500-1 whose volume number of the volume (0x11) in the one generation earlier COW copy destination is set to the copy destination volume number. Then, the PU#1 refers to the address information of the copy information 500-1 to acquire the differential bitmap table 240a.

Thereafter, the PU#1 copies the acquired differential bitmap table 240a to create a differential bitmap table 240d for differential reflection of the remote copy. The differential bitmap table 240d denotes an existence of a differential for each of the sections between the volume (0x01) and the volume (0x11) at this time point.

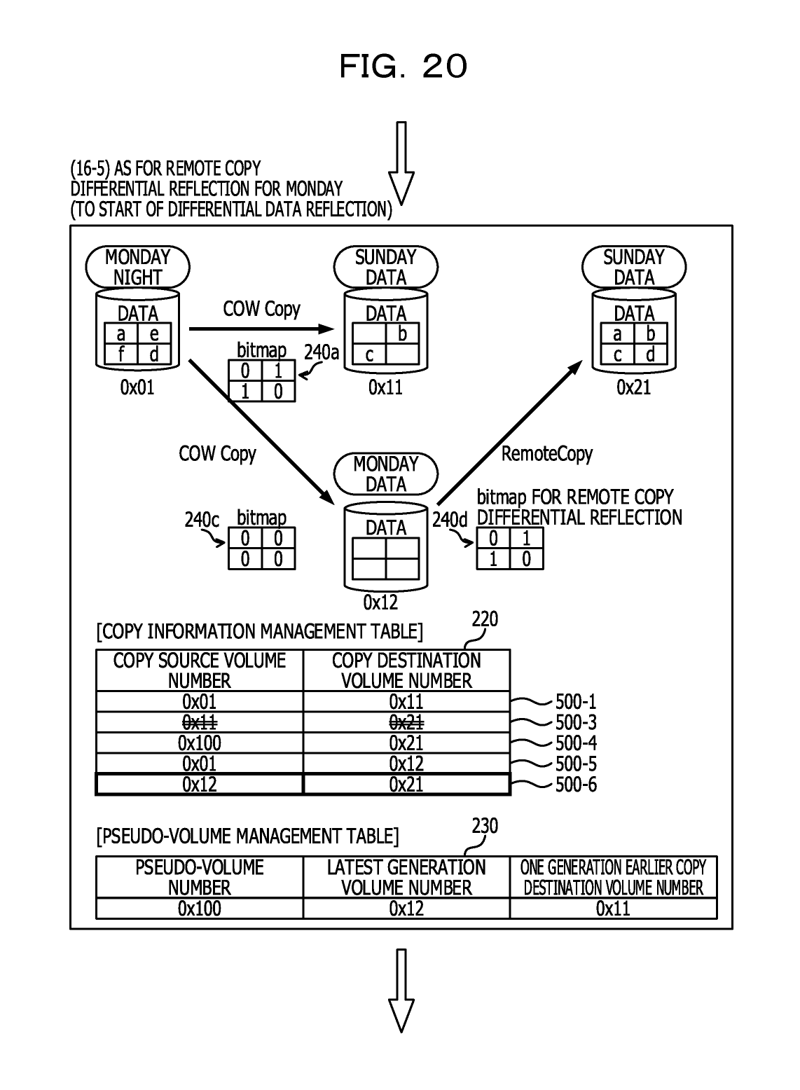

In (16-5) in FIG. 20, the PU#1 deletes the copy information 500-3 of the existing remote copy (0x11=>0x21) from the copy information management table 220. Then, the PU#1 refers to the pseudo-volume management table 230 to start the remote copy from the volume (0x12) in the latest generation COW copy destination to the volume (0x21) in the remote copy destination.

At this time, the PU#1 refers to the differential bitmap table 240d for differential reflection of the remote copy which is created in the (16-4) to specify the section where the differential exists (the differential bit is “1”). Thereafter, the PU#1 refers to the differential bitmap table 240c to extract data corresponding to the specified section from the volume (0x01) or the volume (0x12).

For example, as for the section whose differential bit is “0,” the PU#1 extracts data corresponding to that section from the volume (0x01). On the other hand, as for the section whose differential bit is “1,” the PU#1 extracts data corresponding to the section from the volume (0x12). Then, the PU#1 performs data transfer of the extracted data.

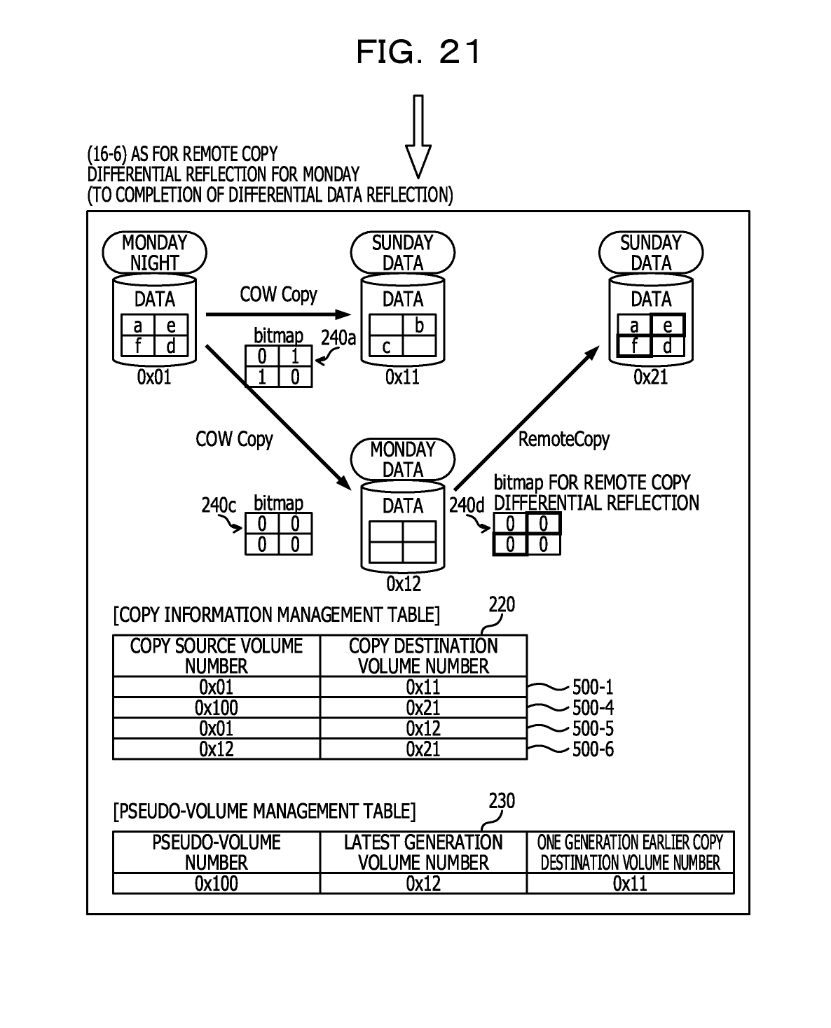

In (16-6) in FIG. 21, as a result of transferring the data in the section where the differential exists, the PU#1 changes the differential bit in the differential bitmap table 240d to “0” with respect to the section where the data transfer is completed. Then, the PU#1 completes the differential reflection for Monday at the time point when all the differential bits in the differential bitmap table 240d become “0.”

(Various Kinds of Processing Procedures of PU#1 in Storage Apparatus 201)

Hereinafter, the description is given of various kinds of processing procedures of the PU#1 in the storage apparatus 201. A COW copy start processing procedure of the PU#1 in the storage apparatus 201 is first described.

<COW Copy Start Processing Procedure>

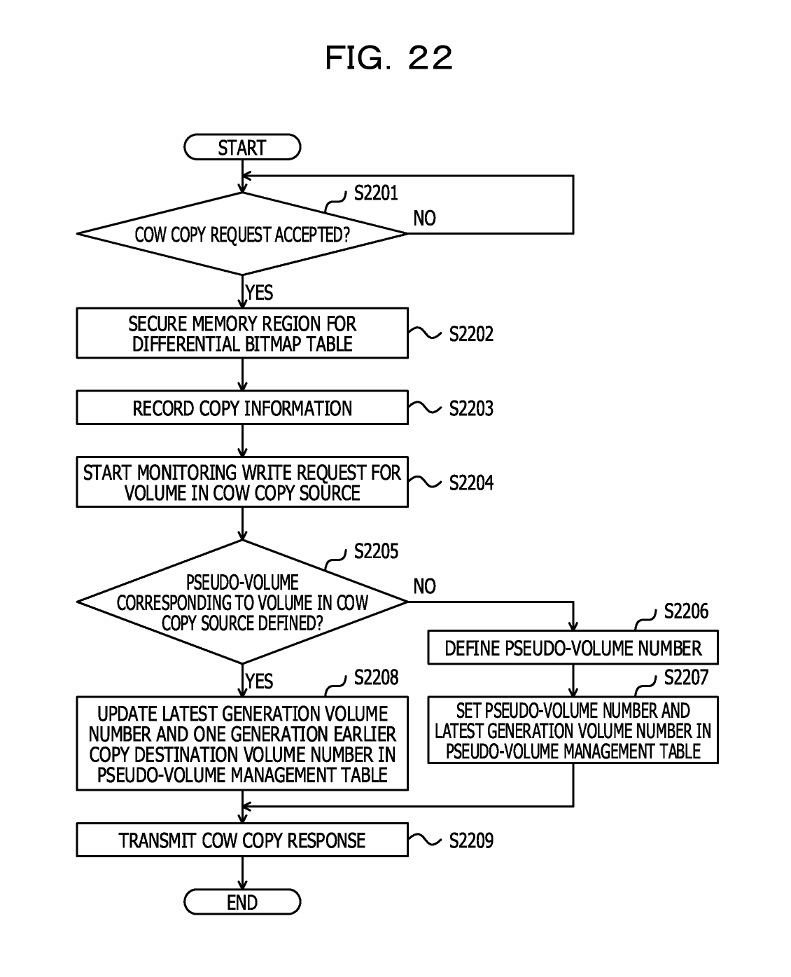

FIG. 22 is a flowchart illustrating an example of a COW copy start processing procedure of the PU#1 in the storage apparatus 201. In the flowchart in FIG. 22, the PU#1 first determines if a COW copy request is accepted from the backup server 204 (step S2201).

Here, the PU#1 waits for accepting the COW copy request (step S2201: No). When the COW copy request is accepted (step S2201: Yes), the PU#1 secures a memory region for the differential bitmap table of the requested COW copy in the memory 402 (step S2202).

Then, the PU#1 refers to the COW copy request to record the copy information in the respective fields of the copy information management table 220 by setting the copy source volume number and the copy destination volume number (step S2203). Thereafter, the PU#1 starts monitoring the WRITE request for the volume in the COW copy source (step S2204).

The PU#1 refers to the pseudo-volume management table 230 to determine if the pseudo-volume corresponding to the volume in the COW copy source is defined (step S2205).

When the pseudo-volume has not been defined (step S2205: No), the PU#1 defines a pseudo-volume number capable of uniquely identifying the pseudo-volume corresponding to the volume in the COW copy source (step S2206). It is noted that the one generation earlier copy destination volume number is “−.”

Thereafter, the PU#1 sets the pseudo-volume number and the latest generation volume number in the respective fields in the pseudo-volume management table 230 (step S2207). After that, the step proceeds to step S2209.

On the other hand, when the pseudo-volume has been already defined (step S2205: Yes), the PU#1 updates the latest generation volume number and the one generation earlier copy destination volume number in the pseudo-volume management table 230 (step S2208).

Then, the PU#1 transmits a COW copy response to the backup server 204 (step S2209), and terminates a series of processing in the present flowchart. Accordingly, the requested COW copy is started in response to the COW copy request from the backup server 204.

<WRITE Processing Procedure>

Hereinafter, the description is given of a WRITE processing procedure of the PU#1 in the storage apparatus 201.

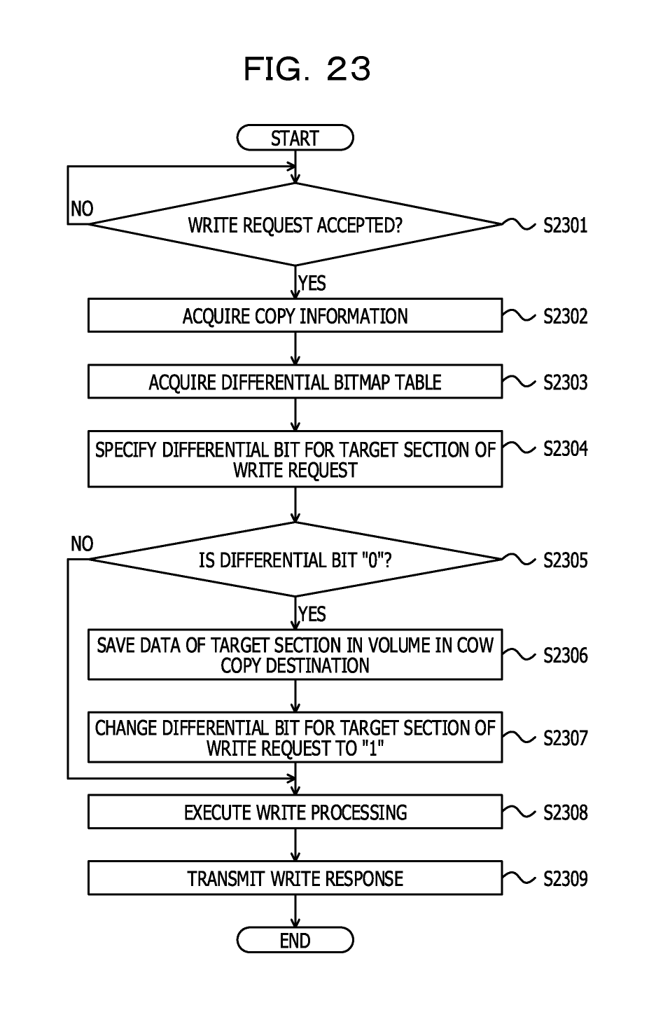

FIG. 23 is a flowchart illustrating an example of a WRITE processing procedure of the PU#1 in the storage apparatus 201. In the flowchart of FIG. 23, the PU#1 first determines if the WRITE request to the volume in the COW copy source is accepted from the business server 203 (step S2301).

The PU#1 waits for accepting the WRITE request here (step S2301: No). When the WRITE request is accepted (step S2301: Yes), the PU#1 acquires copy information in which the volume number of the volume in the COW copy source is set to the copy source volume number from the copy information management table 220 (step S2302).

Then, the PU#1 refers to address information of the differential bitmap table 240 of the acquired copy information to acquire the differential bitmap table 240 from the memory 402 (step S2303). After that, the PU#1 refers to the acquired differential bitmap table 240 to specify the differential bit of a target section of the WRITE request (step S2304).

The PU#1 determines if the specified differential bit is “0” (step S2305). When the differential bit is “1” here (step S2305: No), the PU#1 proceeds to step S2308.

On the other hand, when the differential bit is “0” (step S2305: Yes), the PU#1 saves the data of the target section in the volume in the COW copy source in the volume in the COW copy destination (step S2306). The PU#1 changes the differential bit of the target section of the WRITE request in the differential bitmap table 240 to “1” (step S2307).

The PU#1 executes the requested WRITE processing (step S2308). After that, the PU#1 transmits a WRITE response to the business server 203 (step S2309) and terminates a series of processing in the present flowchart.

In this manner, in response to the WRITE request from the business server 203, when the data has not been saved yet, the data of the target section of the volume in the COW copy source is saved in the volume in the COW copy destination and the requested WRITE processing is executed.

<Remote Copy Start Processing Procedure>

Hereinafter, described is a remote copy start processing procedure of the PU#1 of the storage apparatus 201.

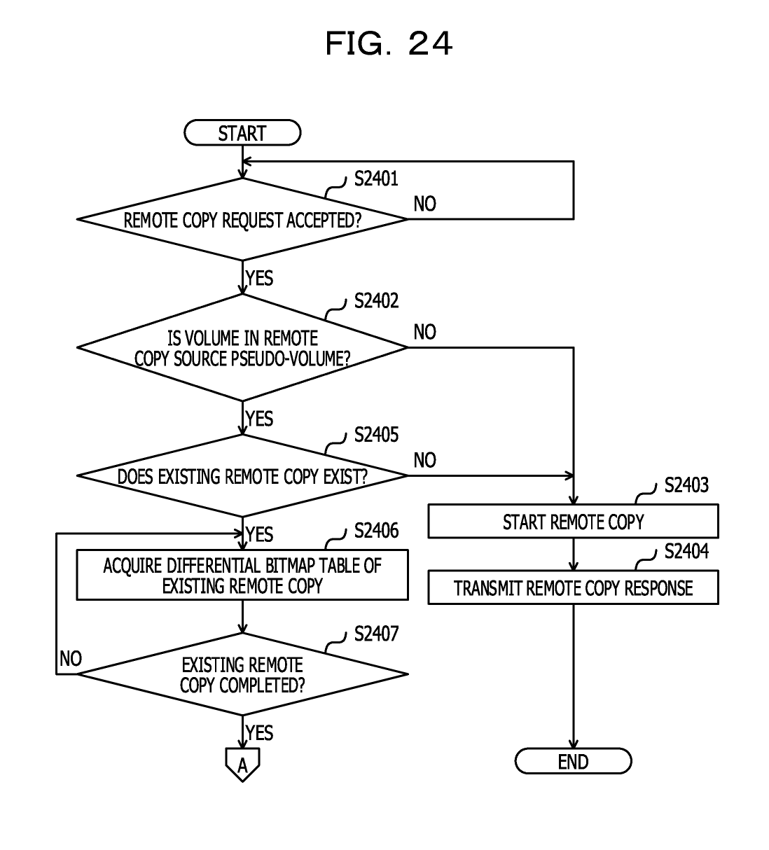

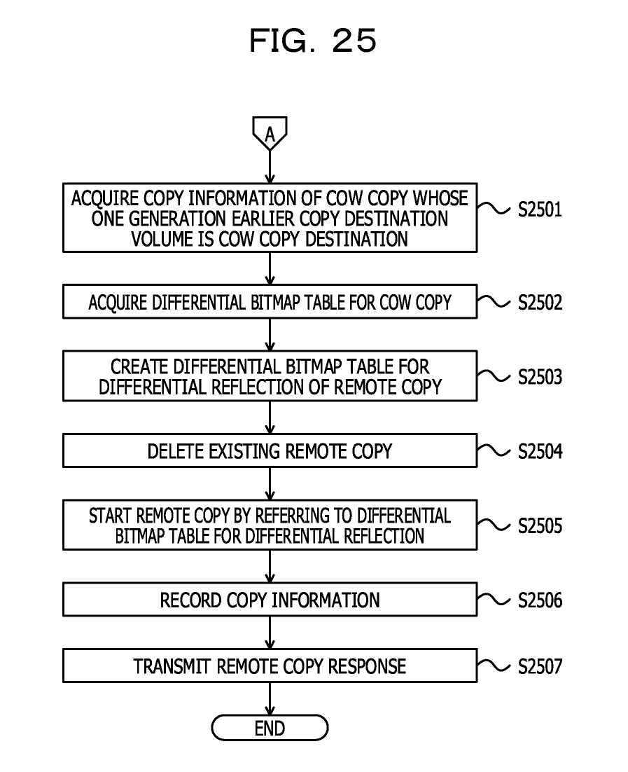

FIGS. 24 and 25 are flowcharts illustrating an example of a remote copy start processing procedure of the PU#1 in the storage apparatus 201. In the flowchart in FIG. 24, the PU#1 first determines if a remote copy request is accepted from the backup server 204 (step S2401).

The PU#1 waits for accepting the remote copy request here (step S2401: No). When the remote copy request is accepted (step S2401: Yes), the PU#1 refers to the pseudo-volume management table 230 to determine if the volume in the remote copy source is a pseudo-volume (step S2402).

When it is not a pseudo-volume (step S2402: No), the PU#1 starts the remote copy between the volumes designated by the remote copy request (step S2403). Then, the PU#1 transmits a remote copy response to the backup server 204 (step S2404) and terminates a series of the processing in the present flowchart.

When it is a pseudo-volume at step S2402 (step S2402: Yes), the PU#1 refers to the copy information management table 220 to determine if the existing remote copy exists (step S2405).

It is noted that the existing remote copy is a remote copy such that the latest generation volume is used as a volume in the remote copy source and a volume in the copy destination designated by the remote copy request is used as the volume in the remote copy destination.

When the existing remote copy does not exist (step S2405: No), the PU#1 proceeds to step S2403.

On the other hand, when the existing remote copy exists (step S2405: Yes), the PU#1 acquires the differential bitmap table 240 of the existing remote copy from the memory 402 (step S2406). The PU#1 refers to the acquired differential bitmap table 240 to determine if the existing remote copy is completed (step S2407).

When the existing remote copy is not completed (step S2407: No), the PU#1 returns to step S2406. On the other hand, when the existing remote copy is completed (step S2407: Yes), the PU#1 proceeds to step S2501 in FIG. 25.

In the flowchart in FIG. 25, the PU#1 first refers to the pseudo-volume management table 230 to acquire copy information of the COW copy whose volume in the one generation earlier copy destination is the volume in the COW copy destination from the copy information management table 220 (step S2501).

Then, the PU#1 refers to the acquired copy information to acquire the differential bitmap table 240 of the COW copy from the memory 402 (step S2502). The PU#1 copies the acquired differential bitmap table 240 to create a differential bitmap table 240 for differential reflection of the remote copy (step S2503).

After that, the PU#1 deletes the copy information of the existing remote copy from the copy information management table 220 to delete the existing remote copy (step S2504). The PU#1 refers to the created differential bitmap table 240 for differential reflection and starts the remote copy between the volumes designated by the remote copy request (step S2505).

Thereafter, the PU#1 records the copy information of the started remote copy in the copy information management table 220 (step S2506). Then, the PU#1 transmits a remote copy response to the backup server 204 (step S2507) and terminates a series of the processing in the present flowchart.

In this manner, the requested remote copy may be started in response to the remote copy request from the backup server 204. In addition, at the time of remote copy update, the copying time may be shortened to time according to an update differential amount with respect to the volume in the COW copy source.

<COW Copy Stop Processing Procedure>

Hereinafter, described is a COW copy stop processing procedure of the PU#1 in the storage apparatus 201.

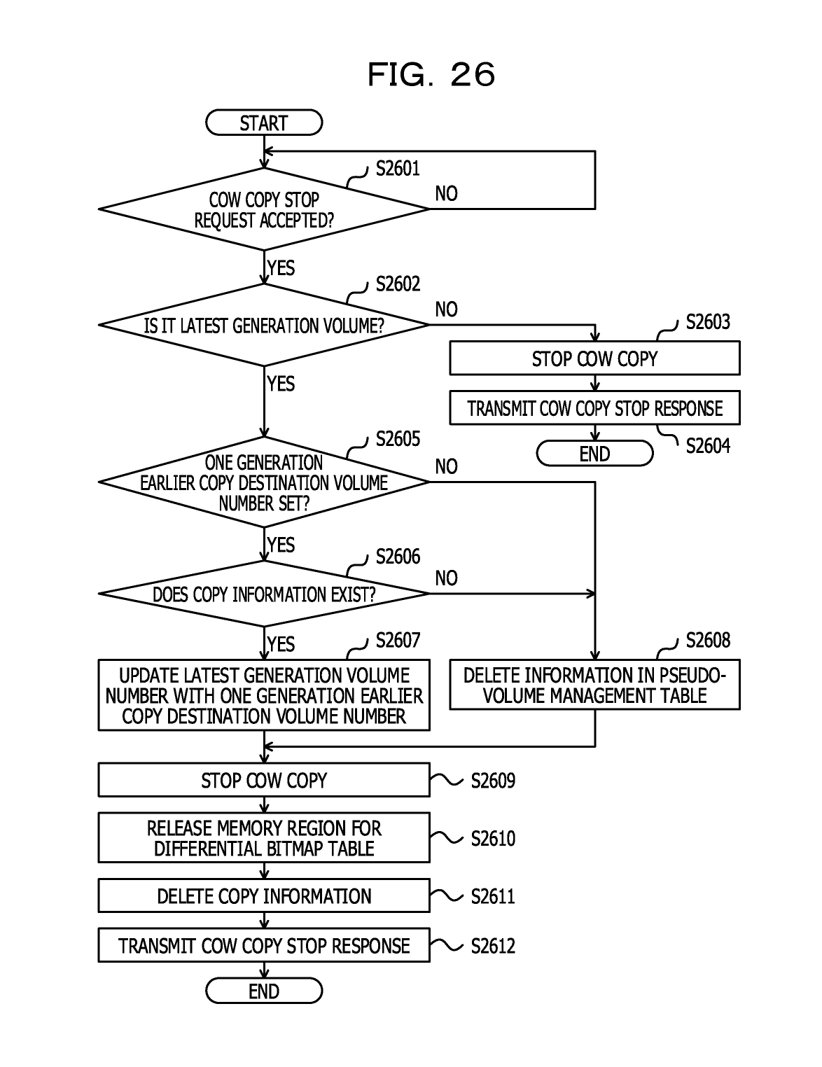

FIG. 26 is a flowchart illustrating an example of a COW copy stop processing procedure of the PU#1 in the storage apparatus 201. In the flowchart in FIG. 26, the PU#1 determines if a COW copy stop request is accepted from the backup server 204 (step S2601).

Here, the PU#1 waits for accepting a COW copy stop request (step S2601: No). When the COW copy stop request is accepted (step S2601: Yes), the PU#1 refers to the pseudo-volume management table 230 to determine if the volume in the COW copy destination of the COW copy designated by the COW copy stop request is set as the latest generation volume (step S2602).

When it has not been set as the latest generation volume (step S2602: No), the PU#1 stops the COW copy between the volumes designated by the COW copy stop request (step S2603). Then, the PU#1 transmits a COW copy stop response to the backup server 204 (step S2604) and terminates a series of the processing in the present flowchart.

At step S2602, when it is set as the latest generation volume (step S2602: Yes), the PU#1 refers to the pseudo-volume management table 230 to determine if the one generation earlier copy destination volume number has been set (step S2605).

When the one generation earlier copy destination volume number has been set (step S2605: Yes), the PU#1 refers to the copy information management table 220 to determine if copy information of the COW copy using the one generation earlier volume as the COW copy destination volume exists (step S2606).

When the copy information exists (step S2606: Yes), the PU#1 updates the latest generation volume number of the pseudo-volume management table 230 with the one generation earlier copy destination volume number and sets the one generation earlier copy destination volume number to “−” (step S2607). Then, the PU#1 proceeds to step S2609.

At step S2605, when the one generation earlier copy destination volume number is not set (step S2605: No), the PU#1 deletes the information in the pseudo-volume management table 230 (the corresponding pseudo-volume information) and proceeds to step S2609.

At step S2606, when the copy information does not exist (step S2606: No), the PU#1 deletes the information in the pseudo-volume management table 230 (the corresponding pseudo-volume information)(step S2608).

Next, the PU#1 stops the COW copy between the volumes designated by the COW copy stop request (step S2609). Then, the PU#1 releases the memory region for the differential bitmap table of the stopped COW copy (step S2610). After that, the PU#1 deletes the copy information of the stopped COW copy from the copy information management table 220 (step S2611).

The PU#1 transmits a COW copy stop response to the backup server 204 (step S2612) and terminates a series of the processing in the present flowchart. In this manner, the stop-requested COW copy is stopped in response to the COW copy stop request from the backup server 204.

As described above, the PU#1 refers to the pseudo-volume management table 230 at the remote copy update to specify the volume in the latest generation COW copy destination and the volume in the one generation earlier COW copy destination. Also, the PU#1 selects data corresponding to a section where an update differential exists between the volume in the COW copy source and the volume in the one generation earlier COW copy destination, as a copy target, from the volumes in the latest generation COW copy destination to be a remote copy source. Accordingly, the copying time for the remote copy update is suppressed to time according to an update differential amount of the one generation earlier COW copy.

In addition, the PU#1 notifies the backup server 204, which is a request source of the remote copy request, of a pseudo-volume number of the pseudo-volume corresponding to the volume in the COW copy source. The PU#1 switches the volume in the COW copy destination to be a remote copy source in association with the pseudo-volume.

In this manner, the switching operation of the volume to be a remote copy source, which is performed by the backup server 204 and a user becomes unnecessary. As a result, an update instruction of the remote copy is made by designating the same remote copy source and remote copy destination at all times. Thus, user operability becomes simpler.

It is noted that the control method is realized by executing a prepared program with a computer such as a personal computer or a work station. The control program is recorded in a computer-readable recording medium such as a hard disk, a flexible disk, a CD-ROM, an MO, or a DVD and is executed in such a manner that the computer reads the program from the recording medium. Also, the control program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device comprising:
a storage configured to store correspondence information associating, with one another, a first volume, a second volume storing data of the first volume at a first time point, and a third volume storing data of the first volume at a second time point after the first time point in a first storage apparatus;
a processor; and
a memory which stores a plurality of instructions, which when executed by the processor, cause the processor to execute:
controlling which extracts data corresponding to a storage region where a differential exists between the first volume and the second volume from the third volume based on the correspondence information in response to an acceptance of a copy request for the data in the first volume at the second time point to a fourth volume in a second storage apparatus in which the data of the first volume at the first time point has been copied and to transmit the extracted data to the second storage apparatus.

2. The device according to claim 1,
wherein the correspondence information includes identification information identifying a pseudo-volume corresponding to the first volume, and
wherein the controlling transmits the identification information to a higher level device controlling backup processing of the data of the first volume and accepts the copy request including the identification information from the higher level device.

3. The device according to claim 1,
wherein the controlling
copies, when an update of the first volume occurs after the first time point, the data of the first volume at the first time point to the second volume by performing the update to the first volume after data before update is coped to the second volume, and
copies, when an update of the first volume occurs after the second time point, the data of the first volume at the second time point to the third volume by performing the uprate to the first volume after data before update is copied to the third volume.

4. The device according to claim 3,
wherein the controlling
refers to first differential bitmap information indicating an existence of a differential between the first volume and the second volume for each of sections formed by dividing the first volume in a certain size unit to specify a section where a differential exits between the first volume and the second volume, and
refers to second differential bitmap information indicating an existence of a differential between the first volume and the third volume for each of the sections to extract data corresponding to the specified section from one of the first volume and the third volume, and transmits the extracted data to the second storage apparatus.

5. A storage control method comprising:
controlling, by a computer processor, in such a manner that, based on correspondence information associating, with one another, a first volume, a second volume storing data of the first volume at a first time point, and a third volume storing data of the first volume at a second time point in a first storage apparatus, in response to an acceptance of a copy request for the data of the first volume at the second time point to a fourth volume in a second storage apparatus in which the data of the first volume at the first time point has been copied, data corresponding to a region where a differential exists between the first volume and the second volume is extracted from the third volume and the extracted data is transmitted to the second storage apparatus.

6. The method according to claim 5,
wherein the correspondence information includes identification information identifying a pseudo-volume corresponding to the first volume, and
wherein the controlling transmits the identification information to a higher level device controlling backup processing of the data of the first volume and accepts the copy request including the identification information from the higher level device.

7. The method according to claim 5,
wherein the controlling
copies, when an update of the first volume occurs after the first time point, the data of the first volume at the first time point to the second volume by performing the update to the first volume after data before update is coped to the second volume, and
copies, when an update of the first volume occurs after the second time point, the data of the first volume at the second time point to the third volume by performing the uprate to the first volume after data before update is copied to the third volume.

8. The method according to claim 7,
wherein the controlling
refers to first differential bitmap information indicating an existence of a differential between the first volume and the second volume for each of sections formed by dividing the first volume in a certain size unit to specify a section where a differential exits between the first volume and the second volume, and
refers to second differential bitmap information indicating an existence of a differential between the first volume and the third volume for each of the sections to extract data corresponding to the specified section from one of the first volume and the third volume, and transmits the extracted data to the second storage apparatus.

9. A computer-readable storage non-transitory medium storing a storage control program that causes a computer to execute a process comprising:
controlling in such a manner that, based on correspondence information associating, with one another, a first volume, a second volume storing data of the first volume at a first time point, and a third volume storing data of the first volume at a second time point in a first storage apparatus, in response to an acceptance of a copy request for the data of the first volume at the second time point to a fourth volume in a second storage apparatus in which the data of the first volume at the first time point has been copied, data corresponding to a region where a differential exists between the first volume and the second volume is extracted from the third volume and the extracted data is transmitted to the second storage apparatus.

10. The medium according to claim 9,
wherein the correspondence information includes identification information identifying a pseudo-volume corresponding to the first volume, and
wherein the controlling transmits the identification information to a higher level device controlling backup processing of the data of the first volume and accepts the copy request including the identification information from the higher level device.

11. The medium according to claim 9,
wherein the controlling
copies, when an update of the first volume occurs after the first time point, the data of the first volume at the first time point to the second volume by performing the update to the first volume after data before update is coped to the second volume, and
copies, when an update of the first volume occurs after the second time point, the data of the first volume at the second time point to the third volume by performing the uprate to the first volume after data before update is copied to the third volume.

12. The medium according to claim 11,
wherein the controlling
refers to first differential bitmap information indicating an existence of a differential between the first volume and the second volume for each of sections formed by dividing the first volume in a certain size unit to specify a section where a differential exits between the first volume and the second volume, and
refers to second differential bitmap information indicating an existence of a differential between the first volume and the third volume for each of the sections to extract data corresponding to the specified section from one of the first volume and the third volume, and transmits the extracted data to the second storage apparatus.
